(19) United States
(12) Patent Application Publication
(10) Pub. No.: US 2025/0017695 A1
(43) Pub. Date: Jan. 16, 2025

(54) ADDITIVE MANUFACTURING OF POLYMER AND METAL DENTAL APPLIANCES

(71) Applicant: Align Technology, Inc., San Jose, CA (US)

(72) Inventors: Jun Sato, San Jose, CA (US); Yuxiang Wang, Newark, CA (US); Umesh Upendra Choudhary, Scotts Valley, CA (US); Viswanath Meenakshisundaram, Santa Clara, CA (US); Chunhua Li, Cupertino, CA (US)

(21) Appl. No.: 18/771,664

(22) Filed: Jul. 12, 2024

Related U.S. Application Data
(60) Provisional application No. 63/513,822, filed on Jul. 14, 2023.

(51) Int. Cl. A61C 7/00; B22F 10/14; B22F 10/18; B22F 10/80; B29C 64/124; B29C 64/386; B29L 31/00; B33Y 10/00; B33Y 50/00; B33Y 80/00

(52) U.S. Cl. CPC A61C 7/002; B22F 10/80; B29C 64/386; B33Y 10/00; B33Y 50/00; B33Y 80/00; B22F 10/14; B22F 10/18; B29C 64/124; B29L 2031/7532

(57) ABSTRACT

Methods for additive manufacturing of polymer and metal dental appliances are provided. In some embodiments, a method includes receiving a digital representation of a dental appliance including a first portion to be formed from a polymeric material and a second portion to be formed from a metallic material. The method can include fabricating the dental appliance using an additive manufacturing process. The additive manufacturing process can include depositing a first composition including a precursor of the polymeric material at the first portion of the dental appliance, and depositing a second composition including a plurality of metal particles at the second portion of the dental appliance.

### CROSS-REFERENCE TO RELATED APPLICATION(S)

The present application claims the benefit of priority to U.S. Provisional Application No. 63/513,822, filed Jul. 14, 2023, the disclosure of which is incorporated by reference herein in its entirety.

### TECHNICAL FIELD

The present technology generally relates to manufacturing, and in particular, to additive manufacturing of polymer and metal dental appliances.

### BACKGROUND

Dental appliances are used to treat various dental conditions, such as dental malocclusions, jaw dysfunction/misalignment, functional and/or aesthetic conditions, endodontic conditions, and others. In some instances, dental appliances fabricated from metals only or from polymers only may not produce satisfactory treatment outcomes. For example, polymeric appliances may lack sufficient mechanical strength for certain types of tooth movements and/or may weaken over time in the warm and humid oral environment. Metal appliances may have improved mechanical properties, but generally lack the workability, customizability, and aesthetics of polymeric appliances. Although hybrid appliances including both polymeric and metallic materials can provide improved characteristics, conventional processes for manufacturing such appliances are less than ideal in at least some respects. For example, conventional techniques for manufacturing hybrid appliances typically involve fabricating the polymeric and metallic portions separately, then assembling these portions to produce the appliance. This process may be time-intensive, difficult to automate, and unsuitable for large scale manufacturing.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 is a flow diagram illustrating a general overview of a method for fabricating a hybrid dental appliance using an additive manufacturing process, in accordance with embodiments of the present technology.

FIG. 2 is a flow diagram illustrating a method for fabricating a polymer and metal dental appliance using an additive manufacturing process, in accordance with embodiments of the present technology.

FIGS. 3A-3F are partially schematic illustrations of an additive manufacturing process, in accordance with embodiments of the present technology.

FIG. 4 is a flow diagram illustrating a method for designing and/or manufacturing a metal and polymer dental appliance, in accordance with embodiments of the present technology.

FIG. 5 is a schematic diagram illustrating a treatment planning and appliance generation workflow, in accordance with embodiments of the present technology.

FIG. 6A illustrates a representative example of a tooth repositioning appliance configured in accordance with embodiments of the present technology.

FIG. 6B illustrates a tooth repositioning system including a plurality of appliances, in accordance with embodiments of the present technology.

FIG. 6C illustrates a method of orthodontic treatment using a plurality of appliances, in accordance with embodiments of the present technology.

FIG. 7 illustrates a metal reinforced polymeric orthodontic aligner, in accordance with embodiments of the present technology.

FIGS. 8A and 8B illustrate metal reinforced polymeric orthodontic aligners with mandibular advancement devices, in accordance with embodiments of the present technology.

FIG. 9 illustrates a positioner with an integrated metal distalizer, in accordance with embodiments of the present technology.

FIG. 10 illustrates a positioner with an integrated power arm, in accordance with embodiments of the present technology.

FIG. 11A is a side view of an aligner having a button, in accordance with embodiments of the present technology.

FIG. 11B is a cross-sectional view of the aligner of FIG. 11A.

FIG. 11C is a cross-sectional view of an aligner having a hook, in accordance with embodiments of the present technology.

FIG. 12A illustrates a metal and polymer retainer with palatal coverage, in accordance with embodiments of the present technology.

FIG. 12B illustrates a metal and polymer palatal expander with a directly fabricated adjustment device, in accordance with embodiments of the present technology.

FIG. 12C illustrates a polymer palatal expander with directly fabricated metal reinforcements, in accordance with embodiments of the present technology.

FIG. 12D illustrates a polymer palatal expander with a metal lattice reinforcement structure, in accordance with embodiments of the present technology.

FIG. 12E illustrates a polymer palatal expander with a metal lattice reinforcement structure, in accordance with embodiments of the present technology.

FIGS. 13A and 13B illustrate a dental appliance including an integrated monitoring device, in accordance with embodiments of the present technology.

FIG. 14 is a perspective view of a housing for a power source of a dental appliance, in accordance with embodiments of the present technology.

FIG. 15 illustrates a method for designing an orthodontic appliance, in accordance with embodiments of the present technology.

FIG. 16 illustrates a method for digitally planning an orthodontic treatment and/or design or fabrication of an appliance, in accordance with embodiments of the present technology.

### DETAILED DESCRIPTION

The present technology relates to additive manufacturing of objects from polymeric and metallic materials. For example, the systems and methods herein can be used to manufacture a dental appliance (e.g., an aligner, palatal expander, retainer, positioner, mouth guard) including a first portion to be formed from a polymeric material and a second portion to be formed from a metallic material. The second portion can encompass one or more regions of the appliance where greater mechanical strength and/or electrical conductivity is desired. For instance, the second portion can be or include a reinforcement structure (e.g., a fiber, bar, lattice, layer, patch), a metallic auxiliary structure (e.g., a hook, button, distalizer, power arm, bracket, wire, spring, palatal expander, lingual retainer), and/or a conductive structure (e.g., a wire, trace, contact, electrode, or antenna).

In some embodiments, a method for manufacturing the dental appliance includes receiving a digital representation of the dental appliance, and fabricating the dental appliance using an additive manufacturing process. The additive manufacturing process can include depositing a first composition comprising a polymerizable material (e.g., a photocurable resin) at the first portion of the dental appliance, and depositing a second composition comprising a plurality of metal particles (e.g., metal nanoparticles) at the second portion of the dental appliance. Optionally, the method can further include causing the metal particles to aggregate, then sintering the metal particles to form a continuous metallic structure. The sintering can be performed at a temperature that does not melt, burn, degrade, or otherwise damage the first portion of the dental appliance that is made from the polymerizable material.

The present technology can provide many advantages for the fabrication of dental appliances and other additively manufactured objects. For instance, the embodiments herein provide hybrid additive manufacturing processes that can be used to produce objects made of polymeric and metallic materials, which can exhibit improved characteristics (e.g., mechanical strength, conductivity, formability) compared to objects that are made from a single type of material. As an example, dental appliances including polymeric and metallic components can exhibit improved durability, provide larger and/or more sustained forces on the teeth, and/or interface with electronic components. Unlike conventional processes for additive manufacturing of metals, which typically require extremely high temperatures (e.g., for metal sintering), the additive manufacturing techniques described herein can be performed at lower temperatures that do not damage the polymeric portions of the object. Accordingly, metallic materials can be incorporated into a polymeric object in a single additive manufacturing operation, thus improving the case, speed, and scalability of fabricating hybrid polymer-metal objects.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Methods and Systems for Manufacturing Polymer and Metal Dental Appliances

The present technology relates to dental appliances made from polymeric and metallic materials, such as aligners, palatal expanders, retainers, attachment placement devices, attachments, oral sleep apnea appliances, positioners, and mouth guards. The dental appliances described herein can be “hybrid” appliances including one or more portions made from a polymeric material, and one or more portions made from a metallic material. The metallic portions can enhance the functionality of the dental appliance, such as by improving the mechanical properties, applying larger and/or more sustained repositioning forces, engaging other devices to produce repositioning forces, and/or interfacing with electronics to confer additional capabilities such as sensing. Additional details and examples of hybrid dental appliances are provided in Section II below.

In some embodiments, the hybrid dental appliances described herein are directly fabricated using an additive manufacturing process. Additive manufacturing (also referred to herein as “3D printing”) includes a variety of technologies which fabricate 3D objects directly from digital models through an additive process. The additive manufacturing process can be a “multi-material” or “hybrid” additive manufacturing process in which the polymeric portions and metallic portions are built up from different materials. In contrast to conventional methods for additive manufacturing of metallic objects, the techniques for fabricating the metallic portions of the appliance described herein can be performed under conditions that do not burn, melt, warp, degrade, or otherwise cause damage to the polymeric portions of the appliance. For instance, the metallic portions can be formed partially or entirely from metal nanoparticles that can be deposited and sintered at relatively low process temperatures (e.g., less than 100° C.). This approach allows the metallic and polymeric portions of the dental appliance to be formed in the same additive manufacturing operation, thus improving manufacturing speed and industrial scalability.

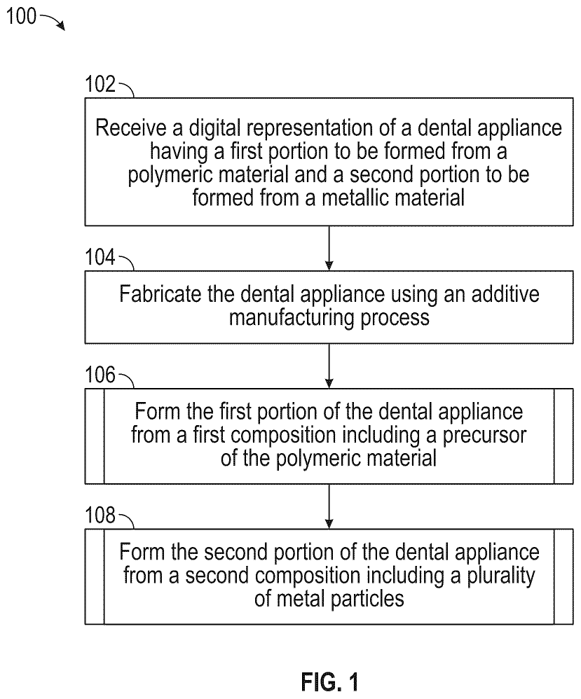

FIG. 1 is a flow diagram illustrating a general overview of a method 100 for fabricating a hybrid dental appliance using an additive manufacturing process, in accordance with embodiments of the present technology. The method 100 can be performed using any suitable system or device, such as a hybrid additive manufacturing system configured to fabricate objects out of polymeric and metallic materials. In some embodiments, some or all of the processes of the method 100 are implemented as computer-readable instructions (e.g., program code) that are configured to be executed by one or more processors of a computing device, such as a controller of the hybrid additive manufacturing system.

The method 100 can begin at block 102 with receiving a digital representation of a dental appliance, such as an aligner, palatal expander, retainer, positioner, sleep apnea appliance, mouth guard, etc. The dental appliance can have at least one first portion to be formed from a polymeric material, and at least one second portion to be formed from a metallic material. The number, geometry, and spatial location of the first portion(s) and second portion(s) can be selected to produce the desired functionality for the dental appliance. For instance, the dental appliance can include one, two, three, four, five, 10, 20, 50 or more polymeric first portions; and/or one, two, three, four, five, 10, 20, 50 or more metallic second portions.

The polymeric first portion(s) and metallic second portion(s) can differ from each other with respect to one or more properties, such as any of the following: stiffness, modulus (e.g., clastic modulus, flexural modulus, storage modulus), strength, hardness, electrical conductivity, magnetism, scratch resistance, creep resistance, roughness, durability, degradability, elongation to break, elongation to yield, color, refractive index, translucency, transparency, porosity, reactivity (e.g., photoreactivity, thermal reactivity) antimicrobial properties, and/or antifungal properties. For example, the metallic second portion(s) can have a greater stiffness, modulus, strength, hardness, scratch resistance, creep resistance, and/or durability than the polymeric first portion(s). As another example, the metallic second portion(s) can be electrically conductive, while the polymeric first portion(s) can be electrically insulative. In a further example, the metallic second portion(s) can exhibit magnetic properties, while the polymeric first portion(s) can exhibit little or no magnetic properties.

In some embodiments, the polymeric first portion(s) define the overall shape of the appliance, while the metallic second portion(s) provide desired functionalities at selected regions of the appliance. For instance, the polymeric first portion(s) can form a polymeric shell including a plurality of tooth-receiving cavities configured to fit over some or all of the teeth on the patient's arch. Optionally, the polymeric shell can include one or more polymeric appliance features, such a receptacle to engage a tooth-mounted attachment, a palatal expander, a mandibular advancement device, a hook, a button, a receptacle for receiving electronic components, etc. The metallic second portion(s) can be disposed at any of the following locations on or within the polymeric shell: an inner surface of the shell, an exterior surface of the shell, a distal region of the shell, a mesial region of the shell, an occlusal region of the shell, a gingival region of the shell, an interproximal region of the shell, a buccal region of the shell, a lingual region of the shell, a location at or proximate to a tooth-receiving cavity, a location spaced apart from a tooth-receiving cavity, a location at or proximate to a polymeric appliance feature (e.g., a receptacle for engaging a tooth-mounted attachment, a palatal expander, a mandibular advancement device, a hook, a button, an receptacle for receiving electronic components), or suitable combinations thereof.

For example, the metallic second portion(s) can form one or more reinforcement structures such as fibers, bars, lattices, layers, patches, etc., that are disposed on or within the shell to provide enhanced mechanical properties, such as increased stiffness, strength, hardness, durability, scratch resistance, and/or creep resistance. The reinforcement structures can also provide increased forces at selected locations on the patient's dentition (e.g., relative to locations where forces are applied by the polymeric shell only). As another example, the metallic second portion(s) can form one or more auxiliary structures integrated with the shell that provide additional functionality for treating the patient's teeth, such as hooks, buttons, distalizers, power arms, brackets, wires, springs, palatal expanders, or lingual retainers. For instance, the auxiliary structure can directly apply a force to the patient's teeth, modify a force applied by the shell to the patient's teeth, and/or interact with another component (e.g., an elastic, another region of the shell, another appliance) to apply force to the patient's teeth. In a further example, the metallic second portion(s) can form one or more conductive structures that are disposed on or within the shell, such as wires, traces, contacts, electrodes, or antennas. In such embodiments, the conductive structure can be configured to electrically couple to at least one electronic component of the dental appliance, such as a battery, a sensor, a monitoring device (e.g., an electronic compliance indicator), or an actuator. Alternatively or in combination, the metallic second portion(s) can provide other types of functionalities, such as antimicrobial and/or antifungal properties and/or magnetic properties (e.g., for sensing, interacting with another magnetic component). Additional details and examples of dental appliances with reinforcement structures, auxiliary structures, conductive structures, and/or other functional components are provided in Section II below.

The digital representation received in block 102 can be a digital file or other digital data structure suitable for controlling the operation of an additive manufacturing system to fabricate the dental appliance. In some embodiments, the digital representation is or includes a 3D digital model representing the geometry of the dental appliance, including the geometry and locations of the first and second portions. For example, the 3D digital model can be a surface model, mesh model, non-parametric model, parametric model, etc. The 3D digital model can be composed of a plurality of 3D elements (e.g., voxels) representing the shape of the dental appliance. The 3D digital model can be provided in any suitable file format, such as a computer-aided design (CAD) file format that can be used to transfer information to and/or control the operation of an additive manufacturing system (e.g., STL file, OBJ file, AMF file, 3MF file). Alternatively or in combination, the digital representation can be or include a series of 2D cross-sections (e.g., slices) that are generated from a 3D digital model of the dental appliance. In embodiments where the dental appliance is to be fabricated using a layer-by-layer additive manufacturing process, the 2D cross-sections can correspond to the individual layers of the dental appliance. The 2D cross-sections can be provided in any suitable file format, such as an image file format (e.g., BMP file, PNG file). Alternatively or in combination, the digital representation can be or include fabrication instructions generated from the 3D digital model and/or 2D cross-sections.

At block 104, the method 100 can include fabricating the dental appliance using an additive manufacturing process. The additive manufacturing process can include depositing one or more precursor materials onto a build platform. The precursor material(s) can be cured, polymerized, melted, sintered, fused, and/or otherwise solidified to form a portion of the dental appliance and/or to combine the portion with previously formed portions of the dental appliance. In some embodiments, the additive manufacturing techniques provided herein build up the appliance geometry in a layer-by-layer fashion, with successive layers being formed in discrete build steps. Alternatively or in combination, the additive manufacturing techniques described herein can allow for continuous build-up of some or all of the appliance geometry.

Examples of additive manufacturing techniques that can be used in the additive manufacturing process of block 104 include, but are not limited to, the following: (1) vat photopolymerization, in which an object is constructed from a vat or other bulk source of liquid photopolymer resin, including techniques such as stereolithography (SLA), digital light processing (DLP), continuous liquid interface production (CLIP), two-photon induced photopolymerization (TPIP), and volumetric additive manufacturing; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) material extrusion, in which material is drawn though a nozzle, heated, and deposited layer-by-layer, such as fused deposition modeling (FDM) and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding. Optionally, the additive manufacturing process can be a hybrid additive manufacturing process that uses a combination of two or more additive manufacturing techniques and/or can be used in conjunction with conventional subtractive manufacturing.

For example, the additive manufacturing process can be or include a vat photopolymerization process in which light is used to selectively cure a vat or other bulk source of a curable material (e.g., a polymeric resin). Each layer of curable material can be selectively exposed to light in a single exposure (e.g., DLP) or by scanning a beam of light across the layer (e.g., SLA). Vat polymerization can be performed in a “top-down” or “bottom-up” approach, depending on the relative locations of the material source, light source, and build platform.

As another example, the additive manufacturing process can be or include a high temperature lithography process (also known as “hot lithography”). High temperature lithography can include any photopolymerization process that involves heating a photopolymerizable material (e.g., a polymeric resin). For example, high temperature lithography can involve heating the material to a temperature of at least 30° C., 40° C., 50° C., 60° C., 70° C., 80° C., 90° C., 100° C., 110° C., or 120° C. In some embodiments, the material is heated to a temperature within a range from 50° C. to 120° C., from 90° C. to 120° C., from 100° C. to 120° C., from 105° C. to 115° C., or from 105° C. to 110° C. The heating can lower the viscosity of the photopolymerizable material before and/or during curing, and/or increase reactivity of the photopolymerizable material. Accordingly, high temperature lithography can be used to fabricate objects from highly viscous and/or poorly flowable materials, which, when cured, may exhibit improved mechanical properties (e.g., stiffness, strength, stability) compared to other types of materials. For example, high temperature lithography can be used to fabricate objects from a material having a viscosity of at least 5 Pa-s, 10 Pa-s, 15 Pa-s, 20 Pa-s, 30 Pa-s, 40 Pa-s, or 50 Pa-s at 20° C. Representative examples of high-temperature lithography processes that may be incorporated in the methods herein are described in International Publication Nos. WO 2015/075094, WO 2016/078838, WO 2018/032022, WO 2020/070639, WO 2021/130657, and WO 2021/130661, the disclosures of each of which are incorporated herein by reference in their entirety.

In some embodiments, the additive manufacturing process can be or include continuous liquid interphase production (also known as “continuous liquid interphase printing”) in which an object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Representative examples of continuous liquid interphase production processes that may be incorporated in the methods herein are described in U.S. Patent Publication Nos. 2015/0097315, 2015/0097316, and 2015/0102532, the disclosures of each of which are incorporated herein by reference in their entirety.

As another example, the additive manufacturing process can be or include a continuous additive manufacturing method that achieves continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474 and U.S. Patent Publication No. 2014/0061974, the disclosures of which are incorporated herein by reference in their entirety. In another example, a continuous additive manufacturing method can involve extruding a composite material composed of a curable liquid material surrounding a solid strand. The composite material can be extruded along a continuous three-dimensional path in order to form the object. Such methods are described in U.S. Patent Publication No. 2014/0061974, the disclosure of which is incorporated herein by reference in its entirety. In yet another example, a continuous additive manufacturing method can utilize a “heliolithography” approach in which the liquid photopolymer is cured with focused radiation while the build platform is continuously rotated and raised. Accordingly, the object geometry can be continuously built up along a spiral build path. Such methods are described in U.S. Patent Publication No. 2014/0265034, the disclosure of which is incorporated herein by reference in its entirety.

In a further example, the additive manufacturing process can be or include a volumetric additive manufacturing (VAM) process in which an entire object or a portion of an object is produced from a 3D volume of resin in a single print step, without requiring layer-by-layer build up. During a VAM process, the entire build volume is irradiated with energy, but the projection patterns are configured such that only certain voxels will accumulate a sufficient energy dosage to be cured. Representative examples of VAM processes that may be incorporated into the present technology include tomographic volumetric printing, holographic volumetric printing, multiphoton volumetric printing, and xolography. For instance, a tomographic VAM process can be performed by projecting 2D optical patterns into a rotating volume of photosensitive material at perpendicular and/or angular incidences to produce a cured 3D structure. A holographic VAM process can be performed by projecting holographic light patterns into a stationary reservoir of photosensitive material. A xolography process can use photoswitchable photoinitiators to induce local polymerization inside a volume of photosensitive material upon linear excitation by intersecting light beams of different wavelengths. Additional details of VAM processes suitable for use with the present technology are described in U.S. Pat. No. 11,370,173, U.S. Patent Publication No. 2021/0146619, U.S. Patent Publication No. 2022/0227051, International Publication No. WO 2017/115076, International Publication No. WO 2020/245456, International Publication No. WO 2022/011456, and U.S. Provisional Patent Application No. 63/181,645, the disclosures of each of which are incorporated herein by reference in their entirety.

In yet another example, the additive manufacturing process can be or include a powder bed fusion process (e.g., selective laser sintering) involving using a laser beam to selectively melt and fuse a layer of powdered material according to a desired cross-sectional shape in order to build up the object geometry. As another example, the additive manufacturing process can be or include a material extrusion process (e.g., fused deposition modeling) process involving melting and selectively depositing a thin filament of material (e.g., thermoplastic polymer) in a layer-by-layer manner in order to form an object. In yet another example, the additive manufacturing process can be or include a material jetting process involving jetting or extruding one or more materials onto a build surface in order to form successive layers of the object geometry (e.g., inkjet printing).

Optionally, the additively manufacturing process can be configured to fabricate an object from a plurality of different materials (e.g., at least two, three, four, five, or more different materials). In some embodiments, the additive manufacturing process is configured to form an object from multiple materials in a single manufacturing step. For instance, a multi-tip extrusion apparatus can be used to selectively dispense multiple types of materials from distinct material supply sources in order to fabricate an object from a plurality of different materials. Examples of such methods are described in U.S. Pat. Nos. 6,749,414 and 11,318,667, the disclosures of which are incorporated herein by reference in their entirety. Alternatively or in combination, the additive manufacturing process can be configured to form an object from multiple materials in a plurality of sequential additive manufacturing operations. For instance, a first portion of the object can be formed from a first material in accordance with any of the fabrication methods herein, then a second portion of the object can be formed from a second material in accordance with any of the fabrication methods herein, and so on, until the entirety of the object has been formed.

In some embodiments, the additive manufacturing process of block 104 is a hybrid additive manufacturing process in which the first portion(s) of the dental appliance are formed from a first composition (block 106) and the second portion(s) of the dental appliance are formed from a second composition (block 108). In some embodiments, the first and second compositions differ from each other with respect to materials (e.g., polymeric versus metallic precursor materials), properties (e.g., viscosity), deposition mechanism (e.g., coating, jetting, extrusion), forming mechanism (e.g., curing, sintering), and/or forming conditions (e.g., energy type, energy wavelength, temperature, exposure time). In other embodiments, the first and second compositions can have the same or similar properties, deposition mechanism, forming mechanism, and/or forming conditions.

For example, at block 106, the polymeric first portion(s) can be formed from the first composition using a first additive manufacturing process. The first composition can be or include at least one precursor that, when exposed to energy, forms the polymeric material. For example, the first composition can be a curable resin. The resin can be composed of one or more polymerizable components (e.g., monomers, oligomers, reactive polymers) that are initially in a liquid state. The resin can be in the liquid state at room temperature (e.g., 20° C.) or at an elevated temperature (e.g., a temperature within a range from 50° C. to 120° C.). When exposed to energy (e.g., light), the polymerizable components of the resin can undergo a polymerization reaction such that the resin solidifies into the desired object geometry. Representative examples of curable polymeric resins and other materials suitable for use with the additive manufacturing techniques herein are described in International Publication Nos. WO 2019/006409, WO 2020/070639, and WO 2021/087061, the disclosures of each of which are incorporated herein by reference in their entirety.

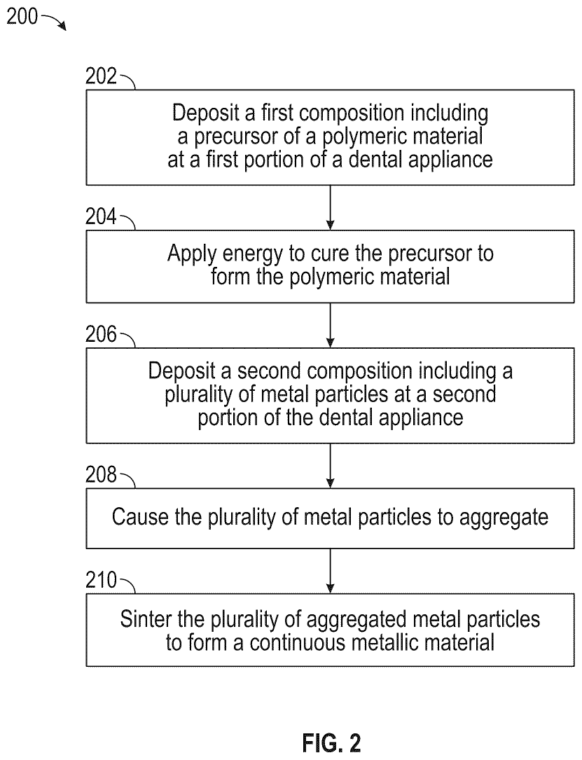

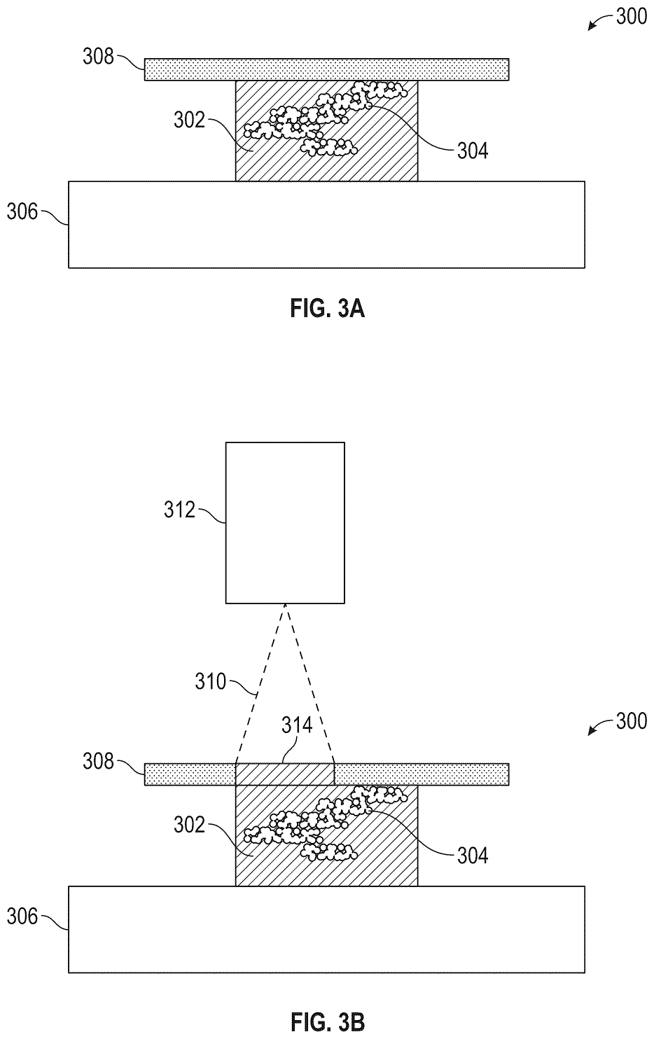

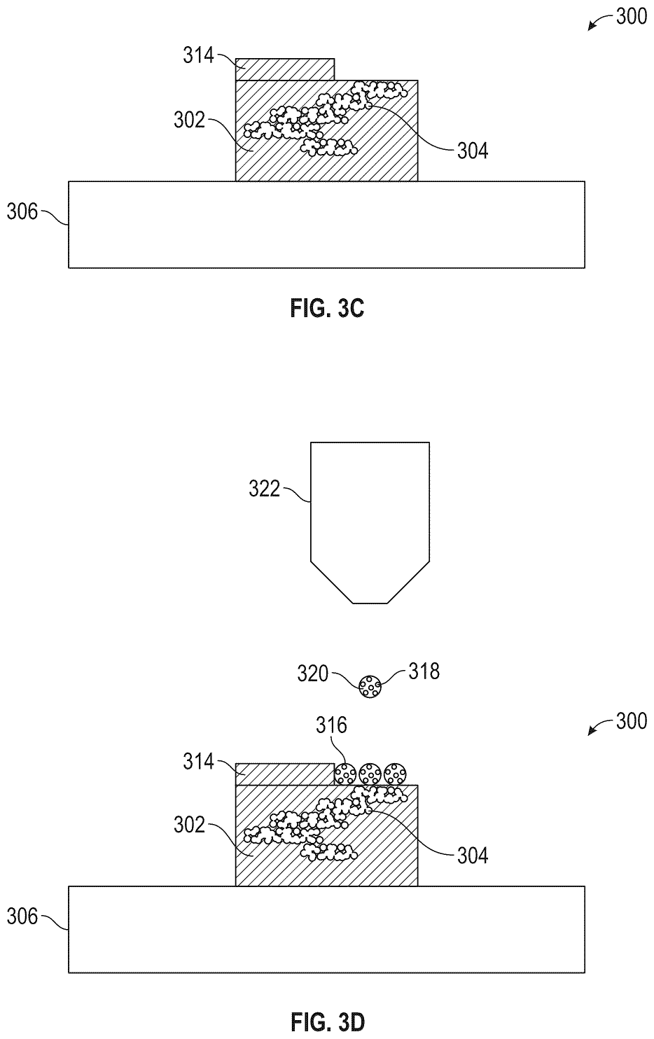

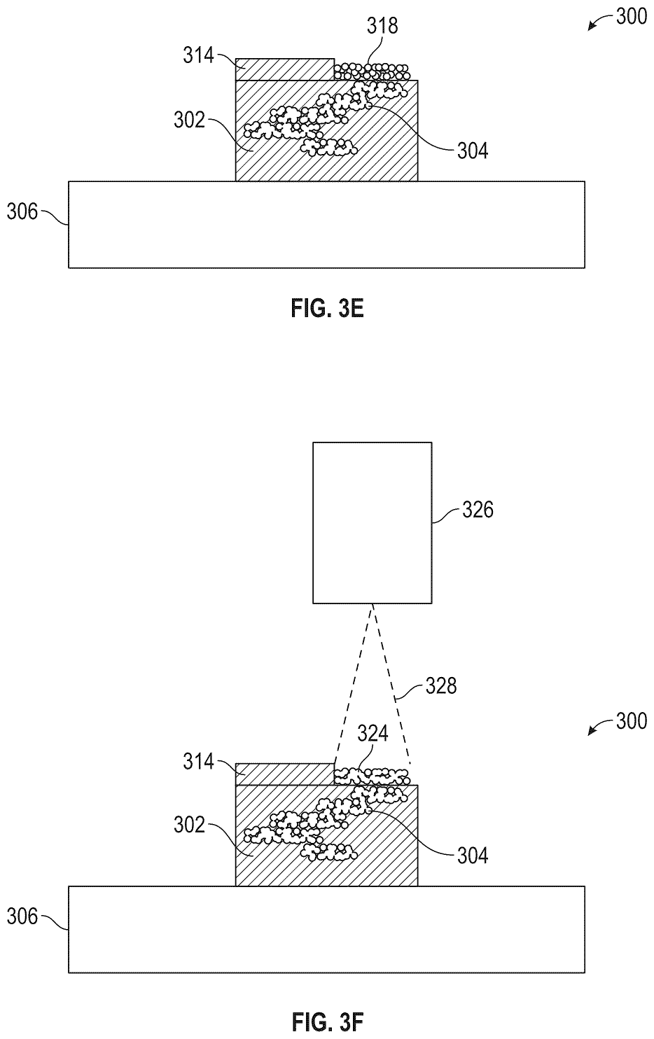

In such embodiments, the first additive manufacturing process can be any additive manufacturing technique suitable for forming the first portion(s) of the dental appliance from the curable resin. For example, the first additive manufacturing process can be a vat photopolymerization process in which the first portion(s) of the dental appliance are built up from a reservoir or other bulk source of the curable resin, as described herein. As another example, the first additive manufacturing process can be a hot lithography process in which a layer of the curable resin is deposited onto a substrate (e.g., a carrier film or build platform) and cured in a desired pattern (e.g., via DLP or SLA) to form the first portion(s). In a further example, the first additive manufacturing process can be a material jetting process (e.g., an inkjet process) or an extrusion process in which the curable resin is deposited onto the build platform at selected locations to form the first portion(s). A representative example of an additive manufacturing process for forming the first portion(s) of the dental appliance from a curable resin is described below in connection with FIGS. 2-3F.

In some embodiments, the first composition is a polymer powder that can be sintered, melted, fused, or otherwise solidified to form the polymeric material of the first portion(s) of the dental appliance. In such embodiments, the first additive manufacturing process can be any additive manufacturing technique suitable for forming the first portion(s) of the dental appliance from the polymer powder. For example, the first additive manufacturing process can be a powder bed fusion process (e.g., SLS) in which the first portion(s) of the dental appliance are formed by applying energy to selected locations on a bed of the polymer powder, as described herein.

At block 108, the metallic second portion(s) can be formed from the second composition using a second additive manufacturing process. The second composition can include a plurality of metal particles. The metal particles can be made out of any suitable metallic material, such as silver, gold, platinum, palladium, copper, nickel, zinc, iron, or titanium, or a compound thereof (e.g., an oxide, a nitride, a nitrate, a carbide, etc., of any of the above metals) or an alloy thereof. The type of metal (or metal compound) can be selected based on the desired function of the metallic second portions of the dental appliance. For example, in embodiments where the metallic second portions are intended to be electrically conductive, the metal particles can be made out of a pure metal (e.g., pure silver, pure copper) that does not form an oxide layer that would interfere with sintering of the particles. In embodiments where the metallic second portions are used for structural reinforcement and/or force application, the metal particles can be made out of a pure metal (e.g., pure silver), a metal that forms an oxide layer (e.g., iron forming iron oxide), or a metal compound. In embodiments where the metallic second portions are intended to have antimicrobial and/or antifungal properties, the metal particles can be made out of a metal having such properties (e.g., silver, copper, gold, zinc).

In embodiments where the metallic second portions are intended to be magnetic, the metal particles can be made out of a metal having magnetic properties (e.g., iron, iron (III) oxide, nickel). In some embodiments, any or all of the metals described herein include magnetic nanoparticles. Examples of magnetic nanoparticles include nanoparticles composed partially or entirely of elements, alloys, etc., made from materials that exhibit magnetism. Examples of materials that exhibit magnetism include materials including iron, cobalt, nickel, manganese, chromium, gadolinium, their chemical compounds, etc. Any or all of the metals described herein can be in bare form, coated with a surface coating and/or functional groups, etc. Examples of any or all of the metals described herein can include iron oxide nanoparticles, e.g., magnetite (Fe₃O₄); maghemite (γ-Fc₂O₃); any material stable over time, biocompatible, and sensitive to magnetic fields; etc. Examples of any or all of the metals described herein can include ferrite nanoparticles and/or materials that exhibit magnetic behavior only in the presence of an external magnetic field. As an example, ferrite nanoparticles can have a size less than 500 nm, 350 nm, 200 nm, 150 nm, 125 nm, 100 nm, 75 nm, etc. The size of ferrite nanoparticles can be chosen to reduce or prevent self-agglomeration.

In some embodiments, the metal particles are nanoparticles, such as nanoparticles having a diameter within a range from 1 nm to 1000 nm, 1 nm to 500 nm, 1 nm to 200 nm, 1 nm to 100 nm, 1 nm to 50 nm, 1 nm to 10 nm, 10 nm to 200 nm, 10 nm to 100 nm, 50 nm to 500 nm, 50 nm to 200 nm, or 50 nm to 100 nm. For instance, the nanoparticles can have a diameter less than or equal to 1000 nm, 900 nm, 800 nm, 700 nm, 600 nm, 500 nm, 400 nm, 300 nm, 250 nm, 200 nm, 150 nm, 125 nm, 100 nm, 75 nm, 50 nm, 25 nm, or 10 nm; and/or greater than 1 nm, 5 nm, 10 nm, 25 nm, 50 nm, 75 nm, 100 nm, 125 nm, 150 nm, 200 nm, 250 nm, 300 nm, 400 nm, or 500 nm.

The use of nanoparticles can confer certain benefits in some instances. For example, nanoparticles may have a lower sintering temperature than macroscopic particles (e.g., particles having a diameter greater than 1 mm), which may be advantageous for avoiding damage to the polymeric portions of the dental appliance, as described further below. For instance, the nanoparticle can be configured to be sintered at a temperature less than or equal to 100° C., 90° C., 80° C., 70° C., 60° C., 50° C., 40° C., 30° C., or 20° C. Nanoparticles can also be advantageous for maintaining the transparency or translucency of the dental appliance for aesthetic purposes. For instance, the concentration of the nanoparticles in the second portion(s) of the appliance can be sufficiently low (e.g., less than 10 wt %, 5 wt %, or 3 wt %) such that the second portion(s) remain transparent or translucent. Alternatively or in combination, the concentration of the nanoparticles in the second portion(s) can be configured to produce a desired degree of transmittance for certain wavelengths of light. Other parameters that can be controlled to achieve the desired degree of translucency include particle size, packing density, and/or nanoscale-level control of nanoparticle location (e.g., using two-photon techniques). In other embodiments, however, the second portion(s) of the dental appliance do not need to be transparent or translucent in the final product. Moreover, the second portion(s) of the dental appliance can alternatively or additionally be fabricated from macroscopic metal particles instead of nanoparticles (e.g., particles having a diameter greater than 1 mm).

The metal particles (e.g., nanoparticles) can have any suitable shape, such as spherical, oval, cylindrical, tubular, prismatic, rod-shaped, fiber-shaped, needle-shaped, plate-shaped, etc. In some embodiments, the metal particles are made out of a single metallic material, while in other embodiments, the metal particles can be made out of two or more metallic materials. For instance, the metal particles can have a core-shell structure in which the inner core is made out of a first metallic material and the outer shell is made out of a second, different metallic material.

Optionally, the metal particles (e.g., nanoparticles) can include surface coatings, treatments, and/or other modifications to modify the properties of the metal particles. For example, the metal particles can be coated, grafted, tagged, or otherwise combined with charged moieties (e.g., a polyanion or polycation) that inhibit aggregation of the metal particles in solution. After the metal particles are deposited at the desired location, the charged moieties can be neutralized (e.g., via addition of a moicty having the opposite charge, such as a polycation or polyanion) and/or cleaved from the metal particles (e.g., via energy, enzymes, chemical reactions) to cause aggregation and/or sintering of the metal particles. For instance, silver nanoparticles that are stabilized by poly (acrylic acid) may spontaneously coalesce upon addition of the cationic polymer poly (diallyldimethylammonium chloride). Alternatively or in combination, the metal particles can be coated, grafted, or otherwise tagged with other types of moieties, such as hydrophilic moieties, hydrophobic moieties, lipophilic moieties, etc.

The second additive manufacturing process can be any additive manufacturing technique suitable for forming the second portion(s) of the dental appliance from the second composition containing the metal particles. For example, the second additive manufacturing process can be a material jetting process (e.g., an aerosol jetting process, an inkjet process, a robotic spray coating process), an extrusion process (e.g., a FDM process, a DIW process), or an electrophotography process (e.g., a selective thermoplastic electrophotographic process). In such embodiments, the second composition can be a fluid composition in which the metal particles are dispersed in a solvent. Accordingly, the second additive manufacturing process can include depositing droplets of the second composition at selected locations to form the second portion(s). In some embodiments, the metal particles are subsequently aggregated and sintered to form a continuous metallic structure, while in other embodiments, the metal particles may remain dispersed. The aggregation of the metal particles can be triggered by removal of some or all of the solvent. Optionally, in embodiments where the metal particles are formed using a solvent and one or more polymers, the polymers may also be removed along with the solvent, or may remain in the appliance as part of the final product. A representative example of an additive manufacturing process for forming the second portion(s) of the dental appliance from a plurality of metal particles is described below in connection with FIGS. 2-3F.

In some embodiments, the second additive manufacturing process uses the same additive manufacturing technique as the first additive manufacturing process. For instance, the first and second additive manufacturing processes can both be material jetting processes, such as an inkjet process. In such embodiments, the polymeric first portion(s) and metallic second portion(s) can be fabricated using a single inkjet additive manufacturing system that includes a first set of nozzles for depositing the first composition at the first portion(s) and a second set of nozzles for depositing the second composition at the second portion(s). The yield strength of the first composition for the polymeric first portion(s) can be sufficiently high to support its shape while the second composition is deposited adjacent to the first portion(s).

Alternatively, the second additive manufacturing process can use a different additive manufacturing technique than the first additive manufacturing process. For example, the first additive manufacturing process can be a DLP or SLA process in which the polymeric first portion(s) are formed by selectively applying energy to a vat or layer of the first composition, while the second additive manufacturing process can be a material jetting process in which the metallic second portion(s) are formed by depositing the second composition from one or more nozzles. As another example, the first additive manufacturing process can be a SLS process in which the polymeric first portion(s) are formed by selectively applying energy to a powder bed of the first composition, while the second additive manufacturing process can be a material jetting process in which the metallic second portion(s) are formed by depositing the second composition from one or more nozzles. In such embodiments, the polymeric first portion(s) and metallic second portion(s) can be fabricated using a hybrid additive manufacturing system that includes hardware components for performing the first additive manufacturing process combined with hardware components for performing the second additive manufacturing process.

The polymeric material of the first portion(s) can be selected to be compatible with the second additive manufacturing process used forming the metallic second portion(s) of the dental appliance. For example, in embodiments where the metal particles are initially dispersed in a solvent, the cured polymeric material can have a crosslink density that is sufficiently low to allow the solvent to migrate away from the deposited metal particles, but sufficiently high to maintain structural integrity of the polymeric first portion(s). Similarly, the solvent can be sufficiently soluble in the cured polymeric material to allow for solvent removal via diffusion. As another example, the cured polymeric material can have a glass transition temperature that is higher than the boiling point of the solvent and/or the sintering temperature of the metal particles. In yet another example, the cured polymeric material can be a material that resists degradation by the solvent. In a further example, the polymeric material and metal particles can be selected to be sufficiently adhesive to each other to ensure that the fabricated dental appliance has sufficient mechanical strength and integrity. In embodiments where the polymeric material is formed via SLS, the first layer of the metal particles can act as a bridge between the different portions of the appliance, and the SLS energy can be used to tune the sintering of the metal particles. Other parameters that can be relevant to polymer-metal process compatibility include the size distribution of the metal particles and the viscoelasticity of the polymeric material (e.g., the plateau modulus range). For instance, the plateau modulus of the polymeric material can be sufficiently high to resist deformation and/or damage during additive manufacturing, even after penetration by the solvent. For instance, the plateau modulus can be within a range from 1×10⁴ Pa to 1×10⁸ Pa.

The processes of blocks 106 and block 108 can be performed in any suitable order, depending on the types of additive manufacturing techniques used, the particular hardware and/or software components of the additive manufacturing system, the geometry of the dental appliance, etc. In some embodiments, the processes of blocks 106 and 108 are performed sequentially, e.g., the additive manufacturing system alternates between fabricating the polymeric first portion(s) and metallic second portion(s); the additive manufacturing system fabricates all of the polymeric first portion(s) before fabricating any of the metallic second portion(s), or vice-versa; and so on. Alternatively, the processes of blocks 106 and 108 can be performed concurrently, e.g., the first and second compositions can be simultaneously deposited to form the first and second portion(s), respectively.

In some embodiments, the processes of blocks 106 and 108 are repeated to build up the dental appliance in a layer-by-layer manner. For example, the polymeric first portion(s) can be incrementally built up from a plurality of layers of the polymeric material and the metallic second portion(s) can be incrementally built up from a plurality of layers of the metallic material. A single layer of the dental appliance can be a “polymer only layer” including the polymeric material without any metallic material, a “metal only layer” including the metallic material without any polymeric material, or a “hybrid layer” including a combination of the polymeric and metallic materials. A hybrid layer can include a first region corresponding to at least one polymeric first portion and a second region corresponding to at least one metallic second portion.

The method 100 illustrated in FIG. 1 can be modified in many different ways. For example, although the above processes of the method 100 are described with respect to a single appliance, the method 100 can be used to sequentially or concurrently fabricate any suitable number of appliances, such as tens, hundreds, or thousands of appliances. Each appliance can be made out of any suitable combination of polymeric and metallic materials.

Moreover, although the method 100 is described in connection with a dental appliance fabricated from a single polymeric material and a single metallic material, in other embodiments, the appliance can be fabricated from a plurality of polymeric materials (e.g., two, three, four, five, or more different polymeric materials) and/or a plurality of metallic materials (e.g., two, three, four, five, or more different metallic materials). In such embodiments, the method 100 can be adapted to accommodate multiple polymeric and/or metallic materials. For instance, the method 100 can include forming a first portion of the dental appliance from a first composition including a precursor of a first polymeric material, forming a second portion of the dental appliance from a second composition including a precursor of a second polymeric material, forming a third portion of the dental appliance from a third composition including a plurality of first metal particles, forming a fourth portion of the dental appliance from a fourth composition including a plurality of second metal particles, and so on.

Additionally, the method 100 can include additional processes not shown in FIG. 1. In some embodiments, after the dental appliance is fabricated, the appliance can undergo one or more additional process steps, also referred to herein as “post-processing.” Post-processing can include removing residual material from the appliance, applying additional energy to the appliance (e.g., to post-cure the polymeric material, to sinter and/or anneal the metallic material), separating the appliance from a build platform and/or support structures, cleaning the appliance (e.g., washing), trimming the appliance to remove structures that are not intended to be present in the final product (e.g., residual parts of the support structures), and/or packaging the appliance for shipment.

FIGS. 2-3F illustrate a representative example of an additive manufacturing process for fabricating a polymer and metal dental appliance, in accordance with embodiments of the present technology. Specifically, FIG. 2 is a flow diagram illustrating a method 200 for fabricating a polymer and metal dental appliance using an additive manufacturing process, and FIGS. 3A-3F are partially schematic illustrations of an additive manufacturing process that can be used with the method 200. The method 200 can be combined with the method 100 of FIG. 1, e.g., the processes of the method 200 can be performed as part of the additive manufacturing process of block 104 of the method 100. The method 200 can be performed using any suitable system or device, such as by a hybrid additive manufacturing system configured to fabricate objects out of polymeric and metallic materials. In some embodiments, some or all of the processes of the method 200 are implemented as computer-readable instructions (e.g., program code) that are configured to be executed by one or more processors of a computing device, such as a controller of the hybrid additive manufacturing system.

The method 200 can be used to fabricate a dental appliance (e.g., an aligner, palatal expander, retainer, positioner, sleep apnea appliance, mouth guard) having at least one first portion to be formed from a polymeric material, and at least one second portion to be formed from a metallic material. For example, FIG. 3A illustrates a dental appliance 300 (shown schematically) having a first portion 302 made from a polymeric material (e.g., a cured resin) and a second portion 304 made from a plurality of metal particles (e.g., metal nanoparticles). The first portion 302 can form an appliance shell configured to fit on some or all of a patient's teeth, while the second portion 304 can form one or more reinforcement structures, auxiliary structures, and/or conductive structures that are disposed within, coupled to, or otherwise incorporated into the appliance shell. In some embodiments, the metal particles of the second portion 304 can enhance the functionality of the appliance shell, such as by improved mechanical characteristics (e.g., stiffness, strength, hardness, durability), electrical conductivity, magnetic properties, and/or antimicrobial/antifungal properties.

The appliance 300 can be fabricated on a build platform 306 in a layer-by-layer manner in which the first portion 302 and second portion 304 are built up from a plurality of layers, each layer having a geometry corresponding to a respective cross-section of the appliance 300. Depending on the geometry and locations of the first portion 302 and second portion 304 of the appliance 300, any of the layers can be a “polymer only layer” including the polymeric material without the metallic material, a “metal only layer” including the metallic material without the polymeric material, or a “hybrid layer” including a combination of the polymeric material and the metallic material. A hybrid layer can include a first region corresponding to the polymeric first portion and a second region corresponding to the metallic second portion.

Referring to FIG. 2, the method 200 can begin at block 202 with depositing a first composition including a precursor of a polymeric material at a first portion of a dental appliance (e.g., a portion of a shell of the dental appliance). The precursor can be any component or combination of components that, when exposed to energy, solidifies to form the first portion of the dental appliance. For example, the first composition can be a curable material (e.g., curable resin), as described herein. The curable material can be composed of one or more monomers, which can be any molecule or compound capable of forming bonds with other monomers, thus resulting in a larger molecule with increased molecular weight. For example, the monomers can be vinylic monomers, cyclic monomers, monomers with functional groups that form covalent or ionic bonds, etc. In some embodiments, the bond-forming reaction occurs multiple times, such that the molecular weight of the resultant molecule increases with each successive bond-forming reaction. Examples of bond-forming reactions suitable for use with the techniques described herein include, but are not limited to, free radical polymerization, ionic polymerization, condensation polymerization, Diels-Alder reactions, photodimerization, carbene formation, nitrene formation, and suitable combinations thereof.

Alternatively or in combination, the curable material can be composed of one or more reactive polymers and/or oligomers. The oligomers and/or polymers can react with each other, monomers, and/or other components to form larger molecules, e.g., via any of the bond-forming reactions described above.

The curable material can include various additives, such as catalysts, blockers, viscosity modifiers, fillers, binders, reactive diluents, solvents, pigments and/or dyes, stabilizers, surface-active compounds, etc. For example, in some embodiments, the curable material includes a catalyst that, when exposed to energy, forms a reactive species that catalyzes a bond-forming reaction. The catalyst can be a photocatalyst that is activated or otherwise created by absorption of light (e.g., infrared light, visible light, or ultraviolet (UV) light). Examples of photocatalysts include, but are not limited to, photoinitiators (e.g., radical initiators, cationic initiators), photoacid generators, and photobase generators.

In some embodiments, the curable material includes a blocker that limits the depth of energy penetration into the curable material during the additive manufacturing process. For example, the blocker can be a photoblocker that absorbs the irradiating wavelength responsible for causing photoreactions (e.g., activation of a photocatalyst or photodimerization reaction).

In some embodiments, the curable material includes a viscosity modifier. The viscosity modifier can be a component that increases the viscosity of the curable material (e.g., a filler, binder, thixotropic agent). Alternatively, the viscosity modifier can be a component that decreases the viscosity of the curable material (e.g., reactive diluent, solvent).

In some embodiments, the curable material includes a filler. The filler can be an organic or inorganic filler, such as fumed silica, core-shell particles, talc, titanium dioxide, sugar, nanocellulose, graphite, carbon black, carbon nanotubes, etc.

In some embodiments the curable material includes a binder. The binder can be a high molecular weight polymer that is added to the curable material to increase the viscosity and/or to enhance various material properties after curing, such as polymethylmethacrylate, acrylonitrile butadiene styrene (ABS), etc.

In some embodiments, the curable material includes a reactive diluent. The reactive diluent can decrease the viscosity of the curable material, while also reacting with one or more other components to form part of the object.

In some embodiments, the curable material includes a solvent. The solvent can decrease the viscosity of the curable material and/or compatibilize two or more components of the curable material.

In some embodiments, the curable material includes a pigment and/or dye. The pigment and/or dye (e.g., titanium dioxide, red dye #40, carbon black) can add color and/or other function to the object.

In some embodiments, the curable material includes a stabilizer configured to stabilize one or more components (e.g., to prevent precipitation, aggregation, degradation). For example, the stabilizer can be an emulsifier that stabilizes the components of an emulsion.

In some embodiments, the curable material includes a surface-active compound. The surface-active compound can enhance wetting or adhesion of the curable material and/or object to another surface. Alternatively or in combination, the surface active compound can facilitate debonding of the curable material and/or object to another surface. Examples or surface-active compounds include, but are not limited to, wax, silicone compounds, silanes, fluorinated compounds, etc.

In some embodiments, the curable material includes components that improve interactions with metallic materials. For instance, the curable material can include thiol compounds and/or thiol groups that can react with gold to form a stronger polymer-metal interface.

Optionally, some or all of the components of the curable material can serve more than one function within the curable material and/or the printed object. For example, reactive diluents can be monomers and can also serve as viscosity modifiers; carbon black can be a pigment and also a photoblocker; and so on.

Additional representative examples of curable materials suitable for use with the additive manufacturing techniques herein are described in International Publication Nos. WO 2019/006409, WO 2020/070639, and WO 2021/087061, the disclosures of each of which are incorporated herein by reference in their entirety.

The first composition can be deposited at the first portion of the dental appliance from a first material source and/or using a first additive manufacturing technique. For example, in the embodiment of FIG. 3A, the first composition is a curable material 308, such as a polymerizable resin. To fabricate an individual layer of the first portion 302, a layer of the curable material 308 is brought into contact with the build platform 306 (when fabricating the first layer of the appliance 300) or with a previously formed portion of the appliance 300 on the build platform 306 (when fabricating subsequent layers of the appliance 300). In some embodiments, the curable material 308 is formed on and supported by a substrate (not shown), such as a film.

Referring again to FIG. 2, at block 204, the method 200 can include applying energy to cure the precursor to form the polymeric material. Any suitable type of energy can be used, such as electromagnetic energy (e.g., infrared light, visible light, ultraviolet light, microwaves), acoustic energy, and/or radiation energy (e.g., alpha radiation, beta radiation, neutron radiation). The energy can cause a change in the precursor to form the polymeric material, such as chemical reactions (e.g., polymerization), melting, coalescing, hardening, solidifying, etc.

For example, referring to FIG. 3B, energy 310 (e.g., light) from an energy source 312 (e.g., a projector, laser, or light engine) is applied to the curable material 308 to form a polymeric material layer 314 on the appliance 300 (or on the build platform 306, when fabricating an initial layer of the appliance 300). The energy 310 can be applied using an SLA technique in which the energy 310 is scanned over one or more selected locations on the curable material 308. Alternatively, the energy 310 can be applied using a DLP technique in which the energy 310 is projected onto one or more selected locations on the curable material 308. The locations of the curable material 308 that are exposed to the energy 310 can polymerize to form the polymeric material layer 314.

Referring next to FIG. 3C, the remaining curable material 308 can then be moved away from the build platform 306 (e.g., by lowering the build platform 306, by moving the build platform 306 laterally, by raising the curable material 308, and/or by moving the curable material 308 laterally), thus leaving the polymeric material layer 314 in place on the appliance 300 (or on the build platform 306, when forming the initial layer of the appliance 300).

Referring again to FIG. 2, at block 206, the method 200 can continue with depositing a second composition including a plurality of metal particles at a second portion of a dental appliance (e.g., a portion of a reinforcement structure, auxiliary structure, and/or conductive structure of the dental appliance). The metal particles can be made out of any suitable metallic material, and can have any of the characteristics previously described with respect to block 108 of FIG. 1. For example, the metal particles can be metal nanoparticles made partially or entirely out of silver, gold, platinum, palladium, copper, nickel, zinc, iron, or titanium, or a compound thereof (e.g., an oxide, a nitride, a nitrate, a carbide, etc., of any of the above metals) or an alloy thereof.

In some embodiments, the second composition is a fluid (e.g., an ink) including a solvent, and the metal particles are suspended in or otherwise mixed with the solvent. The solvent can be an aqueous solvent or an organic solvent. For example, the solvent can be or include water, an alcohol, a glycol ether (e.g., diethylene glycol butyl ether), acetone, tetrahydrofuran (THF), dioxane, or a combination thereof. The solvent can be sufficiently volatile and/or soluble with the polymeric material to allow the solvent to be subsequently removed to cause aggregation of the metal particles, as described further below. In some embodiments, the solvent is a curable material, such as a photocurable resin, which may be used to create an interconnected porous structure with the metal particles dissolved in the resin. In such embodiments, crosslinking of the photocurable resin may cause phase separation of the metal particles from the resin, resulting in aggregation of the metal particles. The type of solvent can be selected based on the characteristics of the metal particles, such as the composition, particle size, surface energy, hydrophobicity/hydrophilicity, chemical modifications, etc. In some embodiments, the solvent can be selected such that the metal particles remain dispersed and exhibit little or no aggregation. Optionally, the solvent can include a stabilizer (e.g., a surfactant) to inhibit aggregation of the metal particles. For instance, water-based particles can be stabilized using pH modifiers, while amphiphilic particles can be stabilized using zwitterionic compounds. Alternatively or in combination, the solvent can be selected to provide a desired viscosity, e.g., a lower viscosity may be desirable for an inkjet or aerosol jetting process, while a higher viscosity may be desirable for an extrusion process.

The metal particles can be provided in any suitable concentration (w/v %) in the solvent, such as within a range from 1% to 75%, 1% to 50%, 1% to 40%, 1% to 30%, 1% to 25%, 1% to 10%, 1% to 5%, 5% to 75%, 5% to 50%, 5% to 40%, 5% to 30%, 5% to 25%, 5% to 10%, 10% to 75%, 10% to 50%, 10% to 40%, 10% to 30%, 10% to 25%, 25% to 75%, 25% to 50%, 25% to 40%, 25% to 30%, 30% to 75%, 30% to 50%, 30% to 40%, 40% to 75%, 40% to 50%, or 50% to 75%. In some embodiments, the concentration of the metal particles in the solvent is at least 1%, 2%, 5%, 10%, 25%, 30%, 40%, or 50%; and/or no more than 90%, 80%, 75%, 50%, 40%, 30%, 25%, or 10%.

The second composition can be deposited at the second portion of the dental appliance using a second additive manufacturing technique. For example, in the embodiment of FIG. 3D, the second composition is composed of metal particles 318 dispersed within a solvent 320. The second composition can be deposited onto the build platform 306 (when fabricating the first layer of the appliance 300) or with a previously formed portion of the appliance 300 on the build platform 306 (when fabricating subsequent layers of the appliance 300) using a second material source, such as one or more nozzles 322. As shown in FIG. 3D, the nozzle 322 can output the second composition as a plurality of droplets 316, which can be deposited at selected locations corresponding to the second portion 304. Depending on the properties (e.g., surface energy, rheological properties) and placement of the droplets 316, the droplets 316 can coalesce with other deposited droplets 316 or can remain as discrete droplets 316. For example, if the second composition is a relatively viscous and/or thixotropic material, the droplets 316 can retain the same shape or a similar shape once deposited. Optionally, the second composition can be deposited at selected locations to create porous structures, which can be used for reinforcing the appliance 300.

Referring again to FIG. 2, at block 208, the method 200 can optionally include causing the plurality of metal particles to aggregate. In some embodiments, the metal particles spontaneously aggregate when deposited, e.g., due to the surface energy and/or other surface characteristics of the metal particles. Alternatively or in combination, in embodiments where the metal particles are initially dispersed within a solvent, aggregation can be triggered by removing some or all of the solvent, such as via aerosolization, evaporation, diffusion of the solvent away from the metal particles, or suitable combinations thereof. For instance, the metal particles can aggregate when at least 50%, 60%, 70%, 80%, 90%, 95%, or 99% of the solvent initially present in the second composition is removed.

For example, as shown in FIG. 3E, removal of the solvent 320 can cause some or all of the metal particles 318 to aggregate. The solvent 320 can be removed via evaporation, which may occur at room temperature (e.g., 25° C.) or when the appliance 300 is heated to an elevated temperature (e.g., at least 30° C., 40° C., 50° C., 60° C., 70° C., 80° C., 90° C., or 100° C.). In such embodiments, the solvent can have a sufficiently low vapor pressure such that the temperature to evaporate the solvent causes little or no damage to the polymeric material of the first portion 302 of the appliance 300. For example, the evaporation temperature can be at least 5° C., 10° C., 20° C., 30° C., 40° C., 50° C., or 100° C. less than the melting temperature and/or glass transition temperature of the polymeric material. Optionally, a vacuum can be applied to facilitate removal of the solvent 320.

Although FIG. 3E depicts solvent removal from an external surface of the appliance 300, solvent removal can also occur when the metal particles 318 and solvent 320 are within the interior of the appliance 300. In such embodiments, the solvent 320 can be selected to have sufficient solubility in and/or diffusivity with the polymeric material of the first portion 302 so that the solvent 320 can migrate away from the metal particles 318 and into the polymeric material. As described herein, the characteristics of the polymeric material (e.g., crosslink density, solubility) can be selected to allow the solvent to diffuse into the polymeric material. The solvent 320 can subsequently be removed from the polymeric material via evaporation or can remain mixed with the polymeric material (e.g., as a plasticizer).

Additionally, although FIG. 3E illustrates the solvent 320 being removed after deposition of the droplets 316, in other embodiments, some or all of the solvent 320 can be removed during the deposition process. For instance, if the metal particles 318 are deposited via an aerosol jetting process, the solvent 320 can be aerosolized and/or evaporated, such that the metal particles 318 are deposited onto the appliance 300 with little or no residual solvent 320.

Referring again to block 208 of FIG. 2, the aggregation of the metal particles can alternatively or additionally be triggered by application of a stimulus, such as a temperature change (e.g., heating), mechanical energy (e.g., vibrations), acoustic energy (e.g., ultrasonic energy), application of a magnetic field, addition of an agent (e.g., a chemical compound that interacts with the metal particles to cause aggregation), or suitable combinations thereof. Optionally, aggregation of the metal particles can be caused by shrinking the polymeric material surrounding the metal particles, such as via dehydration and/or exposure to acid or divalent cations. In other embodiments, however, the process of block 208 can be omitted such that the metal particles remain dispersed and/or spaced apart from each other, rather than aggregated.

At block 210, the method 200 can optionally include sintering the plurality of aggregated metal particles to form a continuous metallic material. For example, as shown in FIG. 3F, the sintering can cause some or all of the metal particles 318 to coalesce into a unitary, solid, and/or contiguously connected mass, thus forming a continuous metallic structure 324. The metallic structure 324 can form part or all of the second portion 304 of the appliance 300. Sintering may be beneficial if the second portion 304 is intended to be an electrically conductive structure to ensure reliable transmission of electrical signals. Sintering may also be beneficial if the second portion 304 is intended to be used for mechanical reinforcement, since a continuous metallic structure may exhibit enhanced mechanical properties compared to discrete metal particles in some instances.

Referring again to FIG. 2, in some embodiments, the sintering is performed at a sufficiently low temperature to avoid damage to the polymeric material of the first portion of the appliance. For instance, the sintering temperature can be less than or equal to 100° C., 90° C., 80° C., 70° C., 60° C., 50° C., 40° C., 30° C., or 20° C. In some embodiments, the sintering temperature is at least 5° C., 10° C., 20° C., 30° C., 40° C., 50° C., or 100° C. less than the melting temperature and/or glass transition temperature of the polymeric material. The sintering temperature can be related to the characteristics of the metal particle, such as material type, particle size (e.g., nanoparticles may exhibit a lower sintering temperature than macroscopic particles), surface energy, and/or surface chemistry.

The sintering process of block 210 can be performed by applying energy to the metal particles, such as electromagnetic energy (e.g., infrared light, visible light, ultraviolet light, microwaves), acoustic energy, and/or radiation energy (e.g., alpha radiation, beta radiation, neutron radiation). The sintering energy can be the same as the curing energy used in block 204 or can be different from the curing energy (e.g., with respect to energy type, wavelength, exposure time). The sintering energy can increase the temperature of the metal particles to a temperature greater than or equal to a sintering temperature of the metal particles. Optionally, the sintering process may not require application of sintering energy if the environmental temperature is already greater than or equal to the sintering temperature. In some embodiments, the process of block 210 involves applying a dilute acid (e.g., an acid having a pKa within a range from 3 to 5) to trigger the sintering and/or reduce the sintering temperature of the metal particles.

As shown in FIG. 3F, an energy source 326 can be used to apply energy 328 to the plurality of metal particles 318 to sinter them into the continuous metallic structure 324. In the illustrated embodiment, the energy source 326 is a targeted energy source (e.g., a laser, light engine, projector) that selectively applies the energy 328 to the second portion 304 of the appliance 300, such that the first portion 302 of the appliance 300 is not exposed to the energy 328. Alternatively, the energy source 326 can be a nontargeted energy source (e.g., a wide area lamp, oven) that applies the energy 328 to both the first portion 302 and the second portion 304 of the appliance 300.

Referring again to FIG. 2, in other embodiments, the process of block 210 can be omitted such that the metal particles are not sintered. For instance, sintering can be optional if the discrete metal particles can provide sufficient mechanical reinforcement, if the metal particles are not being used to conduct electrical signals, and/or if the metal particles are incorporated primarily or solely for their antimicrobial and/or antifungal properties.

The processes of blocks 204-210 can be performed in any suitable order, depending on the types of additive manufacturing techniques used, the particular hardware and/or software components of the additive manufacturing system, the geometry of the dental appliance, etc. In some embodiments, some or all of the processes of blocks 204-210 are performed sequentially. For example, the additive manufacturing system alternates between depositing and curing the first composition, and depositing, aggregating, and sintering the second composition. Alternatively, some or all of the processes of blocks 204-210 can be performed concurrently. For instance, the curing energy of block 204 can be the same as the sintering energy of block 210, such that the processes of blocks 204 and 210 can be performed simultaneously. In such embodiments, energy can be applied to the first and second portions of the appliance at the same time to produce concurrent curing and sintering. As another example, the solvent of the second composition can be evaporated by the sintering energy, such that the processes of blocks 208 and 210 can be performed simultaneously.

In some embodiments, some or all of the processes of blocks 204-210 are repeated to build up the dental appliance in a layer-by-layer manner. For example, the polymeric first portion can be incrementally built up from a plurality of layers of the polymeric material and the metallic second portion can be incrementally built up from a plurality of layers of the metallic material. A single layer of the dental appliance can be a “polymer only layer” including the polymeric material without any metallic material, a “metal only layer” including the metallic material without any polymeric material, or a “hybrid layer” including a combination of the polymeric and metallic materials. A hybrid layer can include a first region corresponding to the polymeric first portion and a second region corresponding to the metallic second portion.

In some embodiments, some of the processes of blocks 204-210 are repeated while other processes of blocks 204-210 are not repeated. For example, the processes of blocks 204-206 can be repeated, while the process of blocks 208 and 210 can be performed once. In such embodiments, the metal particles may not be aggregated and sintered immediately after deposition. Instead, all of the metal particles within the appliance can be simultaneously aggregated and sintered in a single process step after all of the metallic portions of the appliance have been deposited, such as by exposing the entire appliance to energy that causes evaporation of the solvent and sintering of the metal particles (e.g., via bulk heating of the appliance). In such embodiments, aggregation and sintering can be performed as part of post-processing of the dental appliance, similar to post-curing. Alternatively, the processes of blocks 204-208 can be repeated, while the process of block 210 can be performed once, such that the metal particles are already aggregated before the sintering energy is applied to sinter all the metal particles within the appliance (e.g., via bulk heating of the appliance).

The method 200 of FIG. 2 can be modified in many ways. For example, although the above processes of the method 200 are described with respect to a single appliance, the method 200 can be used to sequentially or concurrently fabricate any suitable number of appliances, such as tens, hundreds, or thousands of appliances. Each appliance can be made out of any suitable combination of polymeric and metallic materials.

Moreover, although the method 200 is described in connection with a dental appliance fabricated from a single polymeric material and a single metallic material, in other embodiments, the appliance can be fabricated from a plurality of polymeric materials (e.g., two, three, four, five, or more different polymeric materials) and/or a plurality of metallic materials (e.g., two, three, four, five, or more different metallic materials). In such embodiments, the method 200 can be adapted to accommodate multiple polymeric and/or metallic materials. For instance, the method 200 can include depositing a first composition including a precursor of a first polymeric material at a first portion of the dental appliance, depositing a second composition including a precursor of a second polymeric material at a second portion of the dental appliance, depositing a third composition including a plurality of first metal particles at a third portion of the dental appliance, depositing a fourth composition including a plurality of second metal particles at a fourth portion of the dental appliance, and so on.

In some embodiments, rather than selectively depositing the second composition at the second portion of the dental appliance, the method 200 can involve depositing a uniform layer of the second composition, then aggregating and/or sintering the metal particles at selected locations to form the second portion of the dental appliance. For instance, sintering energy can be selectively applied to specific locations of the uniform layer of the second composition to sinter the metal particles at those locations. Any remaining unsintered particles can be subsequently removed, e.g., via washing with a solvent.

Some of the processes of the method 200 can be omitted. For example, the processes of block 208 and 210 can be omitted, such that the metal particles remain dispersed within the dental appliance, rather than forming a continuous metallic structure. As another example, the process of block 210 can be omitted, such that the metal particles are aggregated within the dental appliance but are not sintered. Optionally, the metal particles can be aggregated and sintered to form a continuous metallic structure at some locations in the dental appliance, and can remain as discrete particles at other locations in the dental appliance.

The method 200 can also include additional processes not shown in FIG. 2. In some embodiments, after the dental appliance is fabricated, the appliance can undergo one or more additional process steps, also referred to herein as “post-processing.” Post-processing can include removing residual material from the appliance, post-curing the appliance, separating the appliance from a build platform and/or support structures, cleaning the appliance (e.g., washing), trimming the appliance to remove structures that are not intended to be present in the final product (e.g., residual parts of the support structures), and/or packaging the appliance for shipment.

For example, post-curing can be used in situations where the polymeric material of the dental appliance is still in a partially cured “green” state after fabrication. For example, the precursor may be only partially polymerized by the curing energy in block 204. Accordingly, post-curing may be needed to fully cure (e.g., fully polymerize) the polymeric material to its final, usable state. Post-curing can provide various benefits, such as improving the mechanical properties (e.g., stiffness, strength) and/or temperature stability of the polymeric material. Post-curing can be performed by heating the appliance, applying radiation (e.g., UV, visible, microwave) to the appliance, or suitable combinations thereof. Optionally, the post-curing energy can simultaneously sinter and/or anneal the metallic portions of the appliance, as described elsewhere herein. In other embodiments, sintering and/or annealing can be performed before or after post-curing as a separate post-processing step.

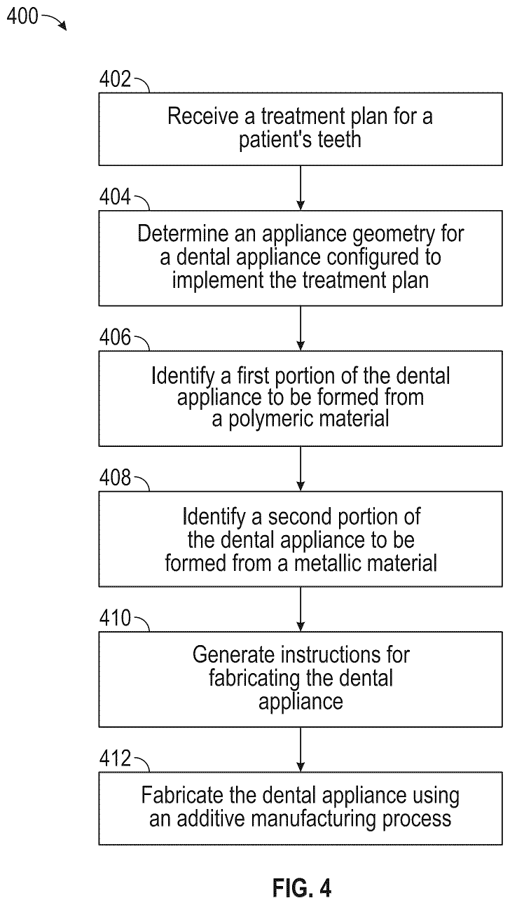

FIG. 4 is a flow diagram illustrating a method 400 for designing and/or manufacturing a metal and polymer dental appliance, in accordance with embodiments of the present technology. The method 400 can be performed using any suitable system or device, such as any of the embodiments described herein. In some embodiments, some or all of the processes of the method 100 are implemented as computer-readable instructions (e.g., program code) that are configured to be executed by one or more processors of a computing device.

The method 400 can begin at block 402 with receiving a treatment plan for a patient's teeth. The treatment plan can include a target arrangement for the teeth and one or more treatment stages for achieving the target arrangement. For example, the treatment stages can be or include a series of intermediate tooth arrangements configured to incrementally reposition the teeth from an initial tooth arrangement toward the target tooth arrangement. The treatment plan can also include other relevant parameters, such as tooth information (e.g., which teeth should or should not be treated, the geometry of the teeth), movement information (e.g., movement direction, movement velocity, movement types such as distalization, root control compound movement, etc.), desired appliance features (e.g., attachments, attachment receptacles, mandibular advancement devices, distalizers, power arms, hooks, buttons, palatal expanders, monitoring devices, and/or electronics), etc.

At block 404, the method 400 can include determining an appliance geometry for a dental appliance configured to implement the treatment plan. The dental appliance can be any of the appliance types provided herein, such as an aligner, palatal expander, retainer, positioner, attachment placement device, oral sleep apnea appliance, mouth guard, etc. In some embodiments, the process of block 404 involves determining a movement path to move one or more teeth from a first position to a second arrangement in accordance with a treatment stage of the treatment plan, then determining a force system configured to move the one or more teeth along the movement path. The force system can then be used to determine a 3D geometry for a dental appliance that would produce the force system, and thus, the desired tooth movements, when worn on the patient's teeth. Alternatively, the appliance geometry can be determined directly based on the tooth movement path, rather than based on the force system. Other inputs that may be used to determine the appliance geometry include inputs from the clinician, patient preferences, simulations, historical data, experimental data, rule-based algorithms, machine learning-based algorithms, or suitable combinations thereof.

For example, the dental appliance can include a shell having a plurality of tooth-receiving cavities configured to apply repositioning forces to one or more teeth of the patient, in accordance with a corresponding treatment stage. The shell can include or be coupled to at least one additional functional component, such as a reinforcement structure configured to enhance the mechanical properties of the shell, an auxiliary structure that provides forces to treat the patient's teeth, and/or a conductive structure configured to electrically couple to an electronic component, as described elsewhere herein. The number, type, location, and/or geometry of the functional components can be determined based on the type of dental appliance to be used, information from the treatment plan (e.g., desired tooth movements and/or the forces to produce the desired tooth movements), input from the clinician, patient preferences, simulations, historical data, experimental data, rule-based algorithms, machine learning-based algorithms, or suitable combinations thereof. For example, a reinforcement structure can be added to the shell if it is determined that the shell alone would be unable to deliver sufficient force to the teeth and/or would be susceptible to damage (e.g., deformation, deflection) when subjected to forces from placement on the teeth. As another example, an auxiliary structure can be added to produce certain types of movements that may be challenging to achieve with the shell alone and/or to allow the shell to engage with other components (e.g., attachments, elastics, another appliance worn on the opposing jaw). In yet another example, a conductive structure can be added to accommodate electronic components (e.g., sensors, monitoring devices).

At block 406, the method 400 can include identifying a first portion of the dental appliance to be formed from a polymeric material. For example, in embodiments where the dental appliance includes a shell with a plurality of tooth-receiving cavities, the first portion can include part of or the entirety of the shell. As another example, the first portion can be identified based on the types and/or amounts of tooth movements to be produced by a particular region of the appliance, the amount of force to be exerted by the region of the appliance, and/or the amount of stress that the region of the appliance is expected to experience during use. In some embodiments, the first portion includes appliance regions that produce smaller tooth movements, exert lower forces, and/or experience lower stresses. In yet another example, the first portion can be identified based on the dental appliance type, information from the treatment plan, input from the clinician, patient preferences, simulations, historical data, experimental data, rule-based algorithms, machine learning-based algorithms, or suitable combinations thereof.

At block 408, the method 400 can include identifying a second portion of the dental appliance to be formed from a metallic material. For example, in embodiments where the dental appliance includes a reinforcement structure, auxiliary structure, and/or conductive structure, the second portion can include the reinforcement structure, auxiliary structure, and/or conductive structure. As another example, the second portion can be identified based on the types and/or amounts of tooth movements to be produced by a particular region of the appliance, the amount of force to be exerted by the region of the appliance, and/or the amount of stress that the region of the appliance is expected to experience during use. In some embodiments, the second portion includes appliance regions that produce larger tooth movements, exert greater forces, and/or experience higher stresses. In yet another example, the second portion can be identified based on the dental appliance type, information from the treatment plan, input from the clinician, patient preferences, simulations, historical data, experimental data, rule-based algorithms, machine learning-based algorithms, or suitable combinations thereof.

In some embodiments, the process of block 408 includes determining an amount of force and/or stress at one or more locations in a polymeric dental appliance (e.g., via simulations), and adding one or more metallic reinforcement structures to the appliance based on the determined forces and/or stresses. For instance, any appliance locations that are associated with forces and/or stresses above a predetermined threshold value can be reinforced using one or more metallic fibers, rods, lattices, layers, patches, etc. The amount of force and/or stress in the reinforced appliance can then be determined, and modifications to the number, geometry, and/or locations of the reinforcement structures can be made in an iterative manner until a satisfactory force and/or stress profile is obtained.

In some embodiments, the process of block 408 includes determining a desired functionality for the dental appliance, and then adding a metallic material to one or more locations in the dental appliance to provide the desired functionality. For example, if the desired functionality is interfacing with an electronic component, such as a battery, sensor, monitoring device, antenna, actuator, etc., metallic conductive structures can be added to one or more appliance locations that are intended to couple to the electronic component. As another example, if the desired functionality is interfacing with a magnetic component, magnetic materials can be added to one or more appliance locations that are intended to interact with the magnetic component.

At block 410, the method 400 can continue with generating instructions for fabricating the dental appliance. The instructions can be configured to control an additive manufacturing system to fabricate the dental appliance with the determined appliance geometry, including the first portion to be formed from the polymeric material and the second portion to be formed from the metallic material. In some embodiments, the instructions include a digital representation of the appliance geometry, such as a 3D digital model (e.g., a surface model, mesh model, non-parametric model, parametric model). The 3D digital model can be provided in any suitable file format, such as a CAD file format (e.g., an STL file, OBJ file, AMF file, 3MF file). Alternatively or in combination, the digital representation can be or include a series of 2D cross-sections (e.g., slices) that are generated from a 3D digital model of the dental appliance. The 2D cross-sections can be provided in any suitable file format, such as an image file format (e.g., BMP file, PNG file). Alternatively or in combination, the instructions can include a toolpath file (e.g., G-code file) that is in a format suitable for direct input to the controller of the additive manufacturing system. The toolpath file can be generated based on the 3D digital model and/or 2D cross-sections of the appliance geometry.

In embodiments where the dental appliance is to be fabricated using a layer-by-layer additive manufacturing process, the 2D cross-sections can correspond to the individual layers of the dental appliance. Depending on the locations of the first and second portions, each individual layer can be a polymer only layer, a metal only layer, or a hybrid layer, as described herein. The instructions for a polymer only layer can cause the additive manufacturing system to deposit a layer of a precursor of the polymeric material, without any metallic material. The instructions for a metal only layer can cause the additive manufacturing system to deposit a layer of metal particles, without any polymeric material. The instructions for a hybrid region can cause the additive manufacturing system to identify a first region to be formed from a polymeric material and deposit a precursor of the polymeric material at the first region of the layer, and identify a second region to be formed from a metallic material and deposit a plurality of metal particles at the second region. In some embodiments, each location in each 2D cross-section (e.g., each pixel or voxel) is labeled with an identifier instructing the additive manufacturing system whether that location is part of the first region and should be formed from the polymeric material, or whether that location is part of the second region and should be formed from the metallic material.

At block 412, the method 400 can include fabricating the dental appliance using an additive manufacturing process. The dental appliance can be directly fabricated using any embodiment of the methods described herein, such as the method 100 of FIG. 1 and/or the method 200 of FIG. 2.

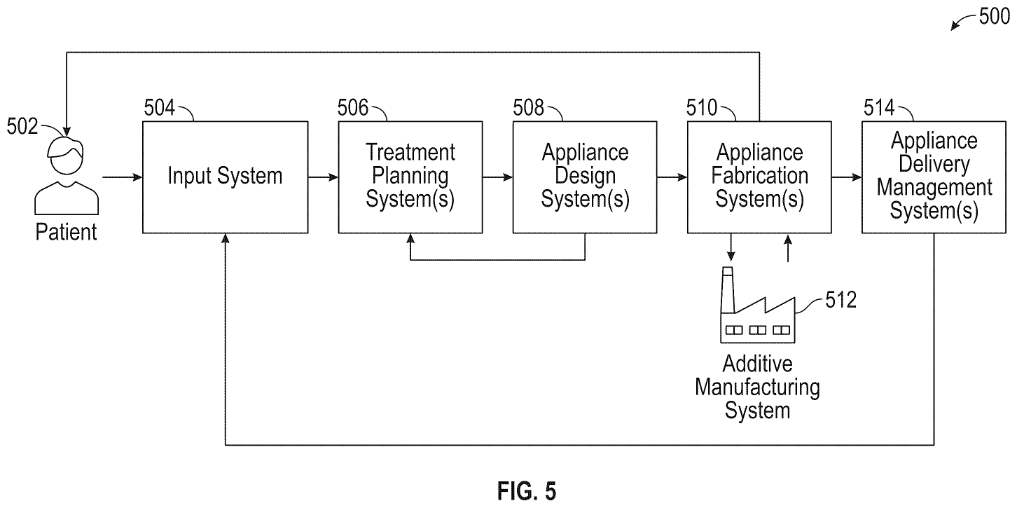

FIG. 5 is a schematic diagram illustrating a treatment planning and appliance generation workflow 500, in accordance with embodiments of the present technology. The workflow 500 can be used to design and fabricate any of the dental appliances described herein, and can incorporate any of the appliance design and manufacturing processes provided herein.

The workflow 500 can begin with generating image data of a current state of dentition of a patient 502. Image data of a patient's dentition, intraoral cavity, and/or other relevant anatomical structures (e.g., craniofacial anatomy). The image data can be generated via any suitable imaging modality, and can include photographs, videos, scan data (e.g., intraoral and/or extraoral scans), magnetic resonance imaging (MRI) data, radiographic data (e.g., standard x-ray data such as bitewing x-ray data, panoramic x-ray data, cephalometric x-ray data, computed tomography (CT) data, cone-beam computed tomography (CBCT) data, fluoroscopy data), and/or motion data. The image data can include 2D data (e.g., 2D photographs or videos), 3D data (e.g., 3D photographs, intraoral and/or extraoral scans, digital models), 4D data (e.g., fluoroscopy data, dynamic articulation data, hard and/or soft tissue motion capture data), or suitable combinations thereof.

In some embodiments, for example, the image data is generated by a scanner configured to obtain a 3D digital representation (e.g., images, surface topography data) of a patient's teeth, such as via direct intraoral scanning or indirectly via casts, impressions, models, etc. The scanner can include a probe (e.g., a handheld probe) for optically capturing 3D structures (e.g., by confocal focusing of an array of light beams). Examples of scanners include, but are not limited to, the iTero® intraoral digital scanner manufactured by Align Technology, Inc., the 3M True Definition Scanner, and the Cerec Omnicam manufactured by Sirona®.

In some embodiments, the image data is processed to generate a digital representation of the dentition of the patient 502. The digital representation can be a 3D model, such as a mesh model or a surface model. Depending on the time the image data was collected, the digital representation can depict the patient's dentition in any suitable arrangement, such as an initial arrangement before the start of a treatment plan, an intermediate arrangement after treatment has commenced, or a final arrangement after the treatment has been completed.

The image data can be transmitted to an input system 504, which can be any system suitable for receiving, processing, and/or storing patient data. For example, the input system can be or include a clinician system associated with a clinician (e.g., an orthodontist, dentist, doctor, or other healthcare provider). The clinician system can provide a clinician software portal allowing the clinician to receive and access information for a patient, such as image data and/or digital representations of the patient's dentition, as well as any other relevant patient data. The clinician software portal can allow the clinician to create and submit a new patient case for treatment planning using the image data, digital representations, and/or other patient data. Alternatively or in combination, the input system 504 can be or include a patient system that provides a patient software portal allowing the patient 502 to communicate with the clinician. The patient software portal can allow the patient 502 to submit images of the patient's teeth obtained via a mobile device (e.g., smartphone) or camera to the clinician system.

The image data and/or digital representations of the patient's dentition can be transmitted to at least one treatment planning system 506. The treatment planning system 506 can generate a treatment plan for the patient's dentition, using the data from the input system 504 and a treatment prescription received from the clinician. For example, the treatment planning system 506 can produce a plurality of digital representations of treatment stages for repositioning the teeth.

The treatment plan can be transmitted by the treatment planning system 506 to at least one appliance design system 508. The treatment planning system 506 can optionally provide other information to the appliance design system 508, such as clinically relevant goals, appliance design parameters, and/or manufacturing constraints. The appliance design system 508 can determine a design for at least one dental appliance configured to implement the treatment plan. For example, the dental appliance can be a hybrid appliance including one or more polymeric portions and one or more metallic portions, such as any of the embodiments described herein. The appliance design process can incorporate at least some of the digital design processes described in connection with the method 400 of FIG. 4. Optionally, the appliance design process can be an iterative process in which an initial appliance design is produced based on the treatment plan and/or design constraints, feedback from the appliance design system 508 is used to update the treatment plan and/or design constraints, the updated treatment plan and/or updated design constraints are used to produce an updated appliance design, and so, until an appliance design that satisfies design constraints and achieves the clinical goals of the treatment plan is determined.

The appliance designs can be transmitted by the appliance design system 508 to at least one appliance fabrication system 510. The appliance fabrication system 510 can use the appliance designs to generate fabrication instructions that control an additive manufacturing system 512 to fabricate the corresponding appliances. For example, the appliance fabrication system 510 and/or the additive manufacturing system 512 can implement a method for fabricating a hybrid appliance, such as any of the methods described herein with respect to FIGS. 1-3F. The fabricated appliances can then be provided to the patient 502 for use. Optionally, the appliance fabrication system 510 can provide information about the fabricated appliances (e.g., appliance order information, shipping information) to at least one appliance delivery management system 514, which can relay such information to the input system 504 (e.g., to the clinician system and/or the patient system).

### II. Dental Appliances and Associated Methods

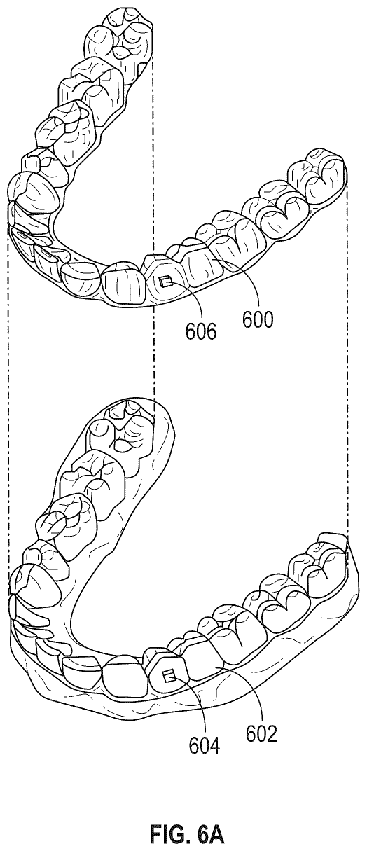

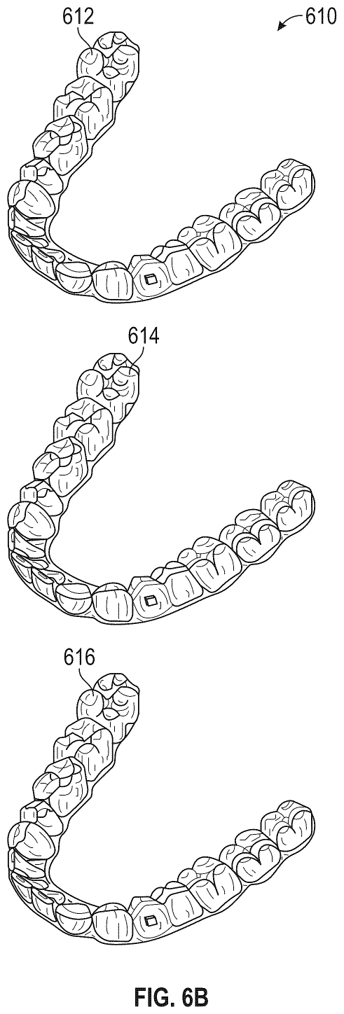

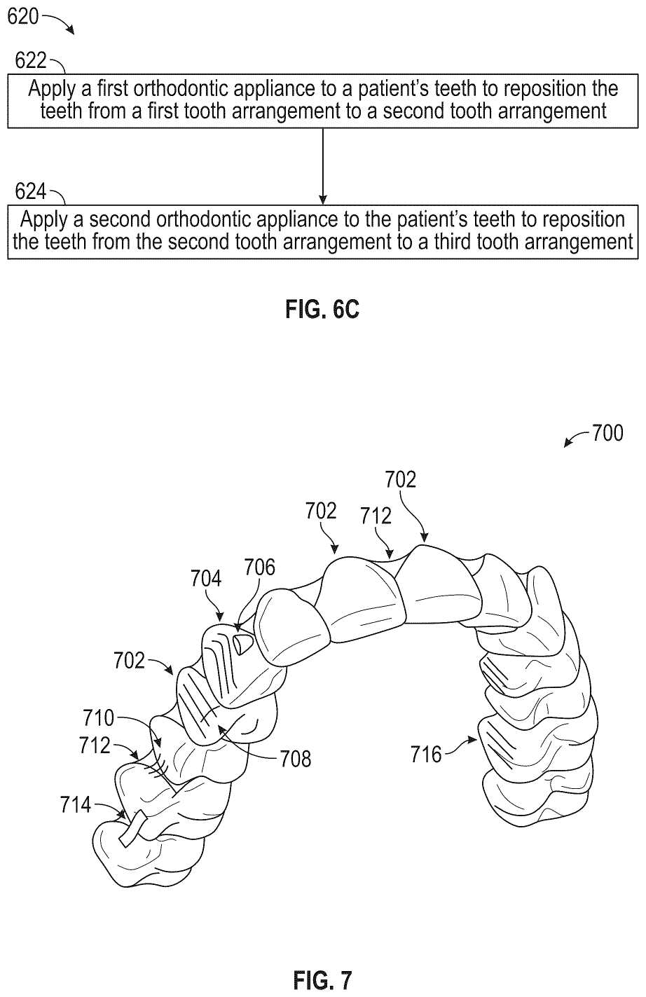

FIG. 6A illustrates a representative example of a tooth repositioning appliance 600 configured in accordance with embodiments of the present technology. The appliance 600 can be manufactured using any of the systems, methods, and devices described herein. The appliance 600 (also referred to herein as an “aligner”) can be worn by a patient in order to achieve an incremental repositioning of individual teeth 602 in the jaw. The appliance 600 can include a shell (e.g., a continuous polymeric shell or a segmented shell) having teeth-receiving cavities that receive and resiliently reposition the teeth. The appliance 600 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 600 can fit over all teeth present in an upper or lower jaw, or less than all of the teeth. The appliance 600 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 600 can be a generic appliance configured to receive the teeth, but not necessarily shaped to match the topography of the patient's teeth. In some cases, only certain teeth received by the appliance 600 are repositioned by the appliance 600 while other teeth can provide a base or anchor region for holding the appliance 600 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 600 in place over the teeth. In some cases, however, it may be desirable or necessary to provide individual attachments 604 or other anchoring elements on teeth 602 with corresponding receptacles 606 or apertures in the appliance 600 so that the appliance 600 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 6B illustrates a tooth repositioning system 610 including a plurality of appliances 612, 614, 616, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 610 can include a first appliance 612 corresponding to an initial tooth arrangement, one or more intermediate appliances 614 corresponding to one or more intermediate arrangements, and a final appliance 616 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 6C illustrates a method 620 of orthodontic treatment using a plurality of appliances, in accordance with embodiments of the present technology. The method 620 can be practiced using any of the appliances or appliance sets described herein. In block 622, a first orthodontic appliance is applied to a patient's teeth in order to reposition the teeth from a first tooth arrangement to a second tooth arrangement. In block 624, a second orthodontic appliance is applied to the patient's teeth in order to reposition the teeth from the second tooth arrangement to a third tooth arrangement. The method 620 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

In some embodiments, the present technology provides hybrid dental appliances (e.g., aligners, palatal expanders, retainers, positioners, attachment placement devices, attachments, oral sleep apnea appliances, mouth guards) including one or more portions made from a polymeric material, and one or more portions made from a metallic material. For example, a hybrid dental appliance can include one or more metallic reinforcement structures that provide enhanced mechanical properties (e.g., increased stiffness, strength, hardness, durability, scratch resistance, and/or creep resistance) to one or more regions of the appliance, and/or apply increased forces to one or more teeth, compared to polymer only appliances. A metallic reinforcement structure can have any suitable form factor, such as fibers, bars, lattices, layers, patches, etc. A hybrid dental appliance can include any suitable number of metallic reinforcement structures, such as one, two, three, four, five, 10, 20, 30, 40, 50, or more reinforcement structures.

As another example, a hybrid dental appliance can include one or more metallic auxiliary structures that confer additional functionality to the appliance, such as hooks, buttons, distalizers, power arms, brackets, wires, springs, palatal expanders, lingual retainers, etc. A metallic auxiliary structure can be any component of a dental appliance that is expected to exert relatively large forces on the patient's teeth and/or is expected to experience relatively large forces and/or stresses. In some embodiments, a metallic auxiliary structure is used to mechanically couple a portion of a dental appliance to another element, such as another portion of the same appliance, another appliance (e.g., worn on the opposing jaw of the patient), a component attached to a patient's tooth (e.g., an attachment), an elastic, etc. A hybrid dental appliance can include any suitable number of metallic auxiliary structures, such as one, two, three, four, five, 10, 20, 30, 40, 50, or more auxiliary structures.

In a further example, a hybrid dental appliance can include one or more metallic conductive structures that allow for transmission of electrical signals such as wires, traces, contacts, electrodes, antennas, etc. A metallic conductive structure can be any component of a dental appliance that is configured to electrically couple to another component, such as a battery, sensor, monitoring device (e.g., an electronic compliance indicator), an actuator, etc. In some embodiments, a metallic conductive structure is used to electrically and/or communicably couple an electronic component of a dental appliance to another element, such as an electronic component of the same appliance, an electronic component of a different appliance (e.g., worn on the opposing jaw of the patient), or an electronic component of a remote device external to the patient's body. A hybrid dental appliance can include any suitable number of metallic conductive structures, such as one, two, three, four, five, 10, 20, 30, 40, 50, or more auxiliary structures.

Optionally, a hybrid dental appliance can include one or more metallic components that provide other functionalities, such as antimicrobial and/or antifungal properties, and/or magnetic properties (e.g., for sensing, interacting with another magnetic component). In some embodiments, a single metallic component can perform multiple different functions, e.g., a reinforcement structure can also serve as a conductive structure, etc.

FIGS. 7-14 provide representative examples of hybrid appliances, in accordance with embodiments of the present technology. The embodiments of FIGS. 7-14 can be designed and manufactured using any of the methods described herein (e.g., in Section I above). Moreover, any of the features of the embodiments of FIGS. 7-14 can be combined with each other and/or with any of the other embodiments of dental appliances provided herein.

FIG. 7 illustrates an example of a metal reinforced polymeric orthodontic aligner 700, in accordance with embodiments of the present technology. The polymeric orthodontic aligner 700 includes a plurality of tooth receiving cavities 702 and one or more metal reinforcement structures, which may be fibers, rods, patches, layer, lattices, bands, and/or other shapes that strengthen the aligner 700 in a particular direction or area. The reinforcement structures may also cause anisotropy in the aligner structure and allow the aligner 700 to have different stiffnesses in different directions. The direction of the stiffness may be determined based on a program tooth movement in an orthodontic treatment plan. For example, the stiffness may be increased in areas with increased force or anticipated force concentrations or in areas where the aligner 700 is likely to bend or deform in an undesirable manner.

One or more metal reinforcement fibers 704 can be used to reinforce the aligner sidewall and/or distribute the forces imparted to an attachment receiving cavity 706 by an attachment when the aligner 700 is worn by a patient. The fibers 704 can extend from a gingival portion of a tooth receiving cavity, such as near a gingival edge of the tooth receiving cavity, towards an occlusal or incisal surface of a tooth receiving cavity. The fibers 704 can be straight, curved, or curvilinear. The fibers 704 can be equidistant from each other or, in some embodiments, the distance between respective fibers 704 may vary. For example, the distance between the fibers 704 can increase as a function of the distance of the fibers 704 from the attachment receiving cavity 706, such that a stress concentration that may otherwise be caused by the fibers may be reduced. In some embodiments, the length of the fibers 704 can increase or decrease as a function of distance from the attachment receiving cavity 706.

One or more metal reinforcement fibers 708 may be used in the sidewalls of a tooth receiving cavity 702 shaped to extrude a tooth without use of attachments. During tooth extrusion, the tooth receiving cavity 702 can act on the undercut of the tooth in order to provide an extrusion force on the tooth. During extrusion, even a slight bow or deformation of the sidewalls of the tooth receiving cavity 702 can reduce the already limited amount of force available to extrude the teeth. Reinforcement fibers 708 can be added to the sidewalls of the tooth receiving cavity 702 for extrusion in order to stiffen the sidewall and reduce or prevent undesirable deformation. The fibers 708 may extend from a gingival location of the tooth receiving cavity 702 towards an occlusal or incisal surface of the tooth receiving cavity 702. In some embodiments, the fibers 708 can extend into the occlusal surface of the tooth receiving cavity. In some embodiments, the sidewalls of the tooth receiving cavity 702 can include two or more fibers 708. The fibers 708 can be arranged parallel to each other. In some embodiments, the tooth receiving cavity 702 can include fibers 708 in one or both of the lingual or buccal sidewalls.

One or more interproximal reinforcement members 710 can extend along an interproximal portion 712 of the aligner 700, between adjacent tooth receiving cavities 702. In the aligner 700, stress concentrations may be formed in the interproximal portion 712 between tooth receiving cavities 702. For example, if a tooth is being distalized or moved in a distal direction, increased forces may be applied across an interproximal region between the distalized tooth and an adjacent tooth. The reinforcement members 710, which can be fibers, mesh, or other metal reinforcements, can be formed within the aligner 700 and extend from a distal portion of a first tooth receiving cavity 702, across an interproximal portion 712, and to a mesial portion of a second, adjacent tooth receiving cavity 702. As shown in FIG. 7, the reinforcement members 710 can include a plurality of fibers arranged parallel to each other and extending along a mesial-distal direction.

In some embodiments, one or more reinforcement members 714 can extend along a plurality of tooth receiving cavities 702 of the aligner 700. For example, the reinforcement members 714 may extend between two or more adjacent tooth receiving cavities 702. In an orthodontic aligner or a retainer, the patient may have a missing tooth or have a large interproximal gap between adjacent teeth. Aligners typically rely on the patient's teeth in order to provide additional structural rigidity to the aligner and to prevent deformations into the teeth. However, if a tooth is missing or the patient has a large interproximal gap, an aligner may be unsupported across a large portion of its length. The unsupported portions of the aligner may deform under relatively low loads and therefore may not be able to transmit forces desired for tooth movement. One or more reinforcement members 714 can be used to stiffen and add strength to the aligner 700 across portions of the aligner 700 where the patient is missing a tooth or an interproximal region. As shown in FIG. 7, the reinforcement member 714, which can be a band, can be formed within the aligner sidewall and extend from a distal portion of a first tooth receiving cavity 702, across an interproximal location, and to a mesial portion of a second, adjacent tooth receiving cavity 702.

Any of the reinforcement structures discussed herein may be placed on a buccal side and/or a lingual side of the aligner 700. For example, as shown in FIG. 7, lingual reinforcement members 716 are placed on or in lingual sidewalls of the aligner 700. Although the reinforcement members 716 are depicted as having similar shapes and relationships as those of reinforcement fibers 708, the reinforcement members 716 can have the shapes, locations, and properties of any of the reinforcement structures described herein. In some embodiments, similar reinforcement members may be placed on both the lingual and buccal sidewalls of the aligner 700.

The reinforcement structures of the aligner 700 can be fabricated using any suitable technique, such as a material jetting process. For example, reinforcement structures within the interior of the aligner 700 (e.g., reinforcement fibers 704, reinforcement fibers 708, reinforcement members 710, reinforcement members 716) can be fabricated using an inkjet process. Reinforcement structures on an exterior surface of the aligner 700 (e.g., reinforcement member 714) can be fabricated using an aerosol jetting process. Optionally, reinforcement members that are aligned (e.g., parallel) with each other (e.g., reinforcement fibers 704, reinforcement fibers 708, reinforcement members 710, reinforcement members 716) can be formed using an external magnetic field to align the metal particles in the desired direction.

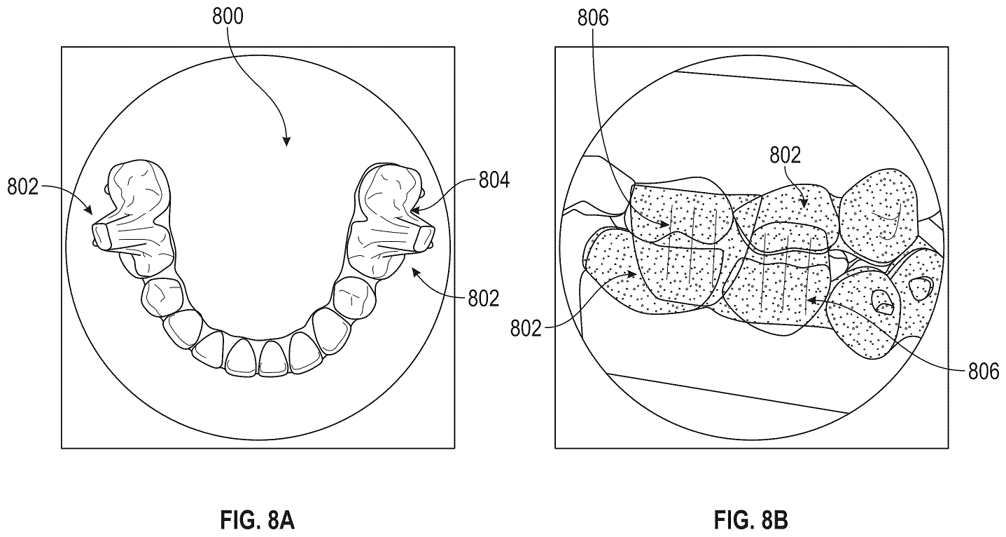

FIGS. 8A and 8B illustrate examples of metal reinforced polymeric orthodontic aligners 800 with mandibular advancement devices 802 (sometimes referred to as “precision wings”), in accordance with embodiments of the present technology. Mandibular advancement devices 802 function to advance mandibula of a patient over time. The upper mandibular advancement device 802 pushes against the lower mandibular advancement device 802 attached to the lower arch of the patient in order to reposition the patient's lower jaw or mandible. Large amounts of force may be applied to each of the mandibular advancement devices 802. The forces may cause deformation and over time may potentially cause buckling and other undesirable deformations of the mandibular advancement devices 802.

Metal reinforcement members (e.g., metal fibers) can be added to the mandibular advancement devices 802 and the portions of the aligner 800 adjacent to the mandibular advancement devices 802 in order to provide added stiffness and durability. The metal reinforcements may also allow for increased forces to be transmitted between the upper and lower mandibular advancement devices 802 as compared to such structures without metal reinforcement.

For example, FIG. 8A shows metal reinforcement members 804 in lingual sidewalls of the mandibular advancement devices 802. The reinforcement members 804 can extend along the mandibular advancement device 802 and into the wall of the adjacent tooth receiving cavities. The reinforcement members 804 can have a greater stiffness and Young's modulus as compared to the polymer in the aligner 800 and the mandibular advancement device 802, which can result in reduced bending and deformation along the mandibular advancement device 802. In some embodiments, the density of the reinforcement members 804 in the aligner 800 can vary based on expected forces or other factors, such as to reduce stress concentrations. For example, as shown in FIG. 8A, the reinforcement members 804 can be present in a greater volume fraction in the sidewalls of the mandibular advancement device 802. In some embodiments, the volume fraction may be reduced as the fibers transition from the mandibular advancement device portion of the aligner 800 into the tooth receiving cavity walls of the aligner 800. This arrangement may reduce stress concentrations that may otherwise develop through the use of metal reinforcement members 804.

FIG. 8B shows metal reinforcement members 806 in the buccal sidewalls of the mandibular advancement devices 802. For example, the reinforcement members 806 can include two or more fibers arranged parallel to each other. The members 806, can extend from a gingival location of the mandibular advancement device 802, across an occlusal plane of the patient's dentition, to a distal end of the mandibular advancement device 802. Optionally, the members 806 can extend beyond an occlusal surface of a patient's dentition or an occlusal surface of a tooth receiving cavity proximate to the mandibular advancement device 802. In some embodiments, a pair of aligners 800 including an upper aligner for the patient's upper arch and a lower aligner for the patient's lower arch is provided. In such embodiments, each of the upper and lower aligners may include respective mandibular advancement devices 802. Each of the mandibular advancement devices 802 may include one or more metal reinforcement members 806, such as the fibers shown in FIG. 8B.

The reinforcement members 804, 806 of the aligners 800 can be fabricated using any suitable technique, such as an inkjet process. Optionally, reinforcement members of the aligners 800 that are aligned (e.g., parallel) with each other (e.g., reinforcement members 804, 806) can be formed using an external magnetic field to align the metal particles in the desired direction.

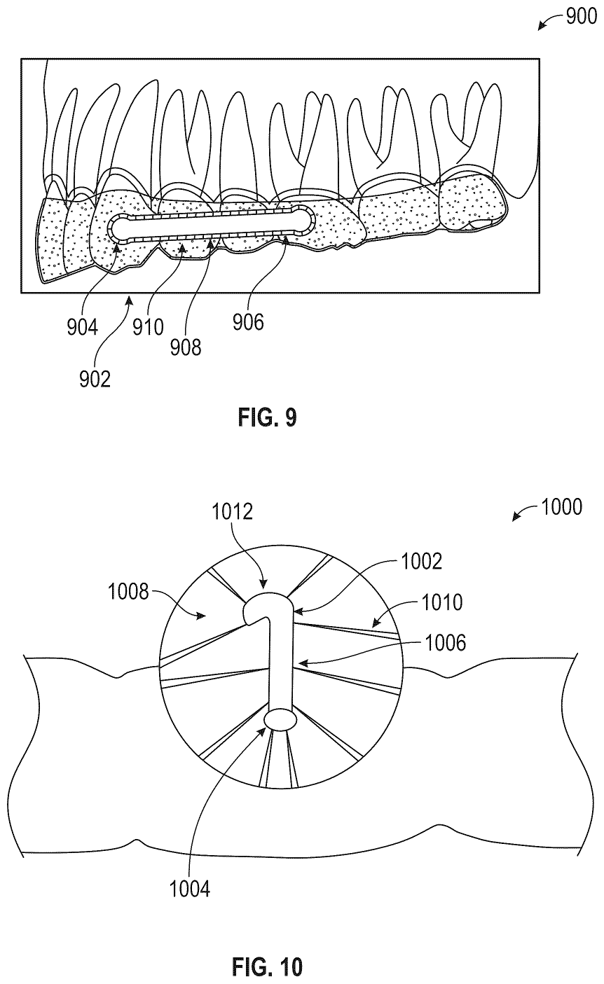

FIG. 9 illustrates an example of a directly fabricated polymeric positioner 900 with an integrated metal distalizer 902, in accordance with embodiments of the present technology. A distalizing device such as the distalizer 902 shown in FIG. 9 can be used to correct alignment of the canine teeth and molars on the upper arch of a patient. The distalizer 902 can attach at a first (e.g., mesial) end 904 to a canine tooth and at a second (e.g., distal) end 906 at a molar. An elastic attached to the first end 904 of the distalizer 902 and a molar on the lower arch, distalizes the canine, premolars, and molars, as a group, while rotating the molar to which the second end 906 of the distalizer 902 is attached. The positioner 900 can include one or more tooth receiving cavities shaped according to the shape of a patient's teeth. The positioner 900 can be shaped such that it can be fit on the patient's arch in a desired location and orientation so as to place the distalizer 902 in an appropriate position according to a treatment plan for repositioning the patient's teeth.

The distalizer 902 can be attached to the positioner 900 via one or more breakable extensions 908 that extend between the integrated distalizer 902 and the positioner 900 across a gap 910 between the integrated distalizer 902 and the positioner 900. The distalizer 902 can be made of metal in order to impart orthodontic tooth movement forces on the teeth, while the positioner 900 and extensions 908 can be made from a polymeric material for weight, cost savings, recyclability, and/or easy breakability of the extensions 908.

During use, the positioner 900 and distalizer 902 are directly fabricated in a single operation. For example, the positioner 900 can be fabricated using a DLP or SLA technique, while the distalizer 902 can be fabricated using material jetting process (e.g., an aerosol jetting process, an inkjet process, a robotic spray coating process), an extrusion process (e.g., a FDM process, a DIW process), or an electrophotography process (e.g., a selective thermoplastic electrophotographic process). The fabricated device is then placed on the patient's teeth and the first end 904 and the second end 906 of the distalizer 902 are attached to the patient's teeth. The extensions 908 can then be broken away from the first end 904, the second end 906, and the shaft of the distalizer 902, and the positioner 900 can be removed from the patient's teeth. An elastic may then be attached to the first end 904 of the distalizer 902 to distalize the patient's teeth.

FIG. 10 illustrates a directly fabricated polymeric positioner 1000 with an integrated power arm 1002, in accordance with embodiments of the present technology. The positioner 1000 can include one or more tooth receiving cavities shaped according to the shape of a patient's teeth. The positioner 1000 can be shaped such that it can be fit on the patient's arch in a desired location and orientation so as to place the power arm 1002 in an appropriate position according to a treatment plan for repositioning the patient's teeth. The power arm 1002 can include a base 1004 for coupling to a tooth, an elongate shaft 1006, and a hook 1008 for engaging an clastic.

The power arm 1002 can be attached to the positioner 1000 via one or more breakable extensions 1010 that extend between the integrated power arm 1002 and the positioner 1000 across a gap 1012 between the integrated power arm 1002 and the positioner 1000. The integrated power arm 1002 can be made of metal in order to impart orthodontic tooth movement forces on the teeth, while the positioner 1000 and extensions 1010 can be made from a polymeric material for weight, cost savings, recyclability, and/or easy breakability of the extensions 1010.

During use, the positioner 1000 and power arm 1002 are directly fabricated in a single operation. For example, the positioner 1000 can be fabricated using a DLP or SLA technique, while the power arm 1002 can be fabricated using material jetting process (e.g., an aerosol jetting process, an inkjet process, a robotic spray coating process), an extrusion process (e.g., a FDM process, a DIW process), or an electrophotography process (e.g., a selective thermoplastic electrophotographic process). The fabricated device is then placed on the patient's teeth and the base 1004 is attached to the patient's teeth. The extensions 1010 can then be broken away from the hook 1008, shaft 1006, and base 1004, and the positioner 1000 can be removed from the patient's teeth. An elastic may then be attached to the hook 1008 of the power arm 1002 in order to apply a force to the patient's teeth.

Although FIGS. 9 and 10 illustrate positioners for a metal distalizer and a metal power arm, respectively, positioners can also be used for placement of other types of auxiliary structures on a patient's teeth. For example, in some embodiments, a directly fabricated polymeric positioner can include an integrated metal lingual retainer. The lingual retainer can be a wire (e.g., a linear, curved, or serpentine wire) that is bonded to the lingual surfaces of one or more anterior teeth to maintain the teeth in a desired arrangement. For example, the lingual retainer can include a first end bonded to a lingual surface of a first canine in a patient's arch, a second end bonded to a lingual surface of a second canine in the patient's arch, and an elongate body extending between the first and second ends that contacts the lingual surfaces of the incisors of the patient's arch.

The lingual retainer can be attached to the positioner via one or more breakable extensions that extend between the integrated lingual retainer and the positioner across a gap between the integrated lingual retainer and the positioner. The integrated lingual retainer can be made of metal in order to apply forces to maintain the positions of the teeth, while the positioner and extensions can be made from a polymeric material for weight, cost savings, recyclability, and/or easy breakability of the extensions.

During use, the positioner and lingual retainer are directly fabricated in a single operation. For example, the positioner can be fabricated using a DLP or SLA technique, while the lingual retainer can be fabricated using material jetting process (e.g., an aerosol jetting process, an inkjet process, a robotic spray coating process) or an extrusion process (e.g., a FDM process, a DIW process). The fabricated device is then placed on the patient's teeth and the lingual retainer is attached to the patient's teeth. The extensions can then be broken away from the lingual retainer, and the positioner can be removed from the patient's teeth.

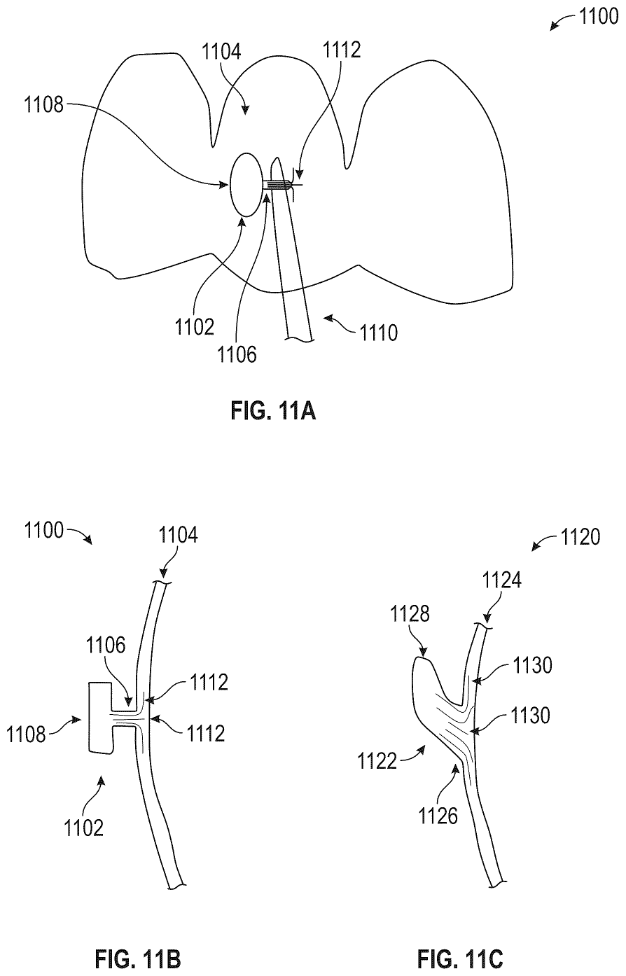

FIGS. 11A and 11B are a side view and cross-sectional view, respectively, of an aligner 1100 having a button 1102 extending from a sidewall 1104 of a tooth receiving cavity, in accordance with embodiments of the present technology. The button 1102 can include a shaft 1106 extending from the sidewall 1104 of the aligner 1100 and terminating at a button head 1108. The shaft 1106 and button head 1108 are cantilevered out from the sidewall 1104 of the aligner and are shaped to receive an elastic 1110 that is used to exert tooth and/or jaw moving forces to the patient's arches. In some embodiments, the force imparted on the shaft 1106 by the elastic 1110 and the cantilevered structure of the shaft 1106 may cause increased loads at the base of the shaft 1106 and the sidewall 1104 of the aligner 1100. In addition, the shape of the post-aligner junction may also cause a stress concentration between the shaft 1106 and the sidewall 1104 of the tooth receiving cavity of the aligner 1100.

Metal reinforcement members 1112 can be formed within the shaft 1106 and the sidewall 1104. For example, the metal reinforcement members 1112 can have a first end within the shaft 1106 of the button 1102, extend through the junction between the shaft 1106 and the sidewall 1104, and terminate at a second end within the sidewall 1104 of the tooth receiving cavity. First portions of the one or more reinforcement members 1112 can extend parallel to each other along the length of the shaft 1106. Second portions of the one or more reinforcement members 1112 may extend radially outward from the shaft 1106 within the sidewall 1104 of the tooth receiving cavity.

In some embodiments, for example, as shown in FIG. 11B, the first end of a reinforcement member 1112 may be located within the head 1108 of the button 1102. A first portion of the reinforcement member 1112 can extend from the first end and radially inward towards the junction of the shaft 1106 with the head 1108. A second portion may extend parallel with the length of the shaft 1106 from the junction of the button 1102 to the junction with the sidewall 1104 of the tooth receiving cavity. A third portion of the reinforcement member 1112 can extend radially outward from the junction of the shaft 1106 within the sidewall 1104.

The reinforcement members 1112 of the aligner 1100 can be fabricated using any suitable technique, such as an inkjet process. Optionally, portions of the reinforcement members 1112 that are aligned (e.g., parallel) with each other (e.g., the portions within the shaft 1106) can be formed using an external magnetic field to align the metal particles in the desired direction.

FIG. 11C is a cross-sectional view of an aligner 1120 having a hook 1122 extending from a sidewall 1124 of the tooth receiving cavity, in accordance with embodiments of the present technology. The hook 1122 can include a shaft 1126 extending from the sidewall 1124 of the aligner 1100 and terminating at a tip 1128. The shaft 1126 and tip 1128 extend from the sidewall 1124 of the aligner 1120 and are shaped to receive an elastic that is used to exert tooth and/or jaw moving forces to the patient's arches. In some embodiments, the force imparted on the hook 1122 by the clastic may cause increased loads at the base of the shaft 1126 and the sidewall 1124 of the aligner 1120. In addition, the shape of the shaft-aligner junction may also cause a stress concentration between the shaft 1126 and the sidewall 1124 of the tooth receiving cavity of the aligner 1120.

Metal reinforcement members 1130 can be formed within the hook 1122 and the sidewall 1124. For example, the metal reinforcement members 1130 can have a first end within the shaft 1126, extend through the junction between the shaft 1126 and the sidewall 1124, and can end at a second end within the sidewall 1124 of the tooth receiving cavity. First portions of the one or more reinforcement members 1130 can extend parallel to each other along the length of the shaft 1126. Second portions of the one or more reinforcement members 1130 can extend radially outward from the shaft 1126 within the sidewall 1124 of the tooth receiving cavity. In some embodiments, the reinforcement members 1112 can extend from the tip 1128 of the hook 1122 through the shaft 1126, and into the sidewall 1124 of the tooth receiving cavity. In some embodiments, the reinforcement members 1130 follow the contour of the external surface of the hook 1122 and the sidewall 1124.

The reinforcement members 1130 of the aligner 1120 can be fabricated using any suitable technique, such as an inkjet process. Optionally, portions of the reinforcement members 1130 that are aligned (e.g., parallel) with each other (e.g., the portions within the shaft 1126) can be formed using an external magnetic field to align the metal particles in the desired direction.

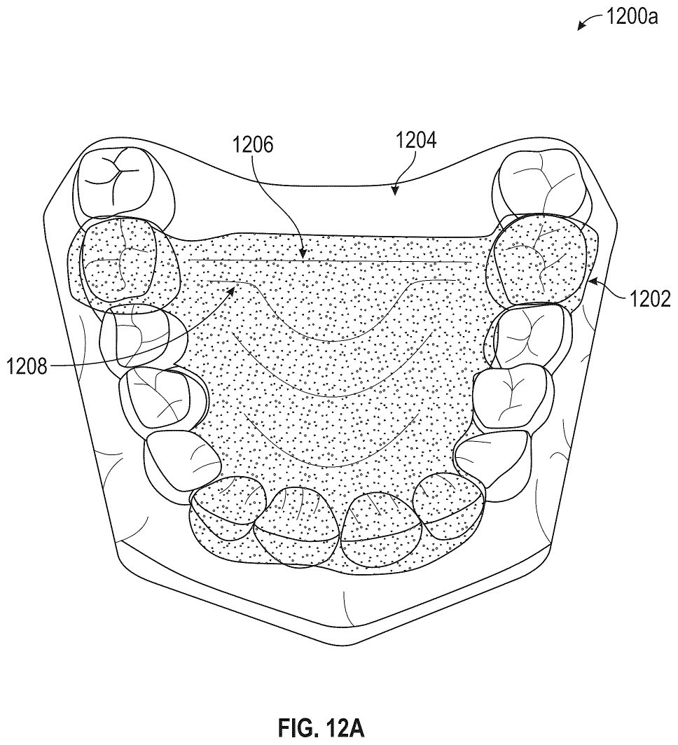

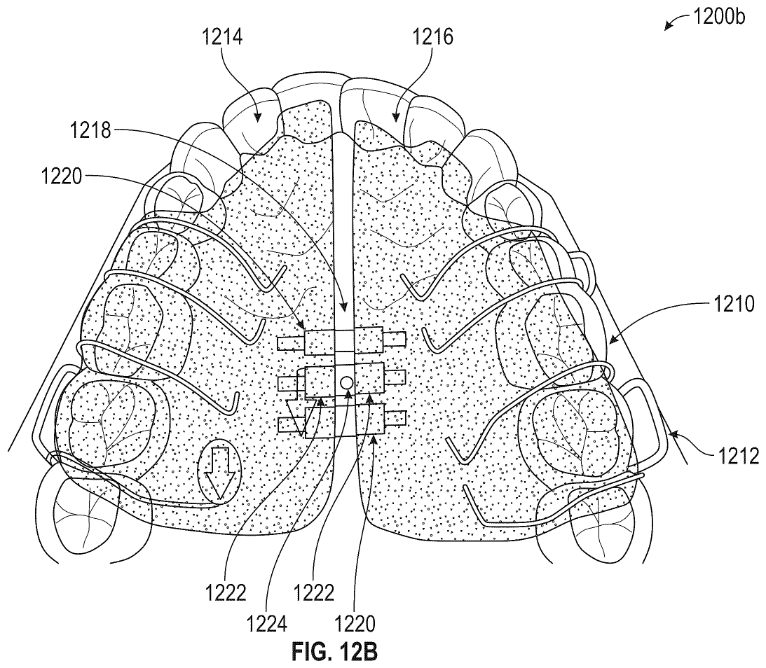

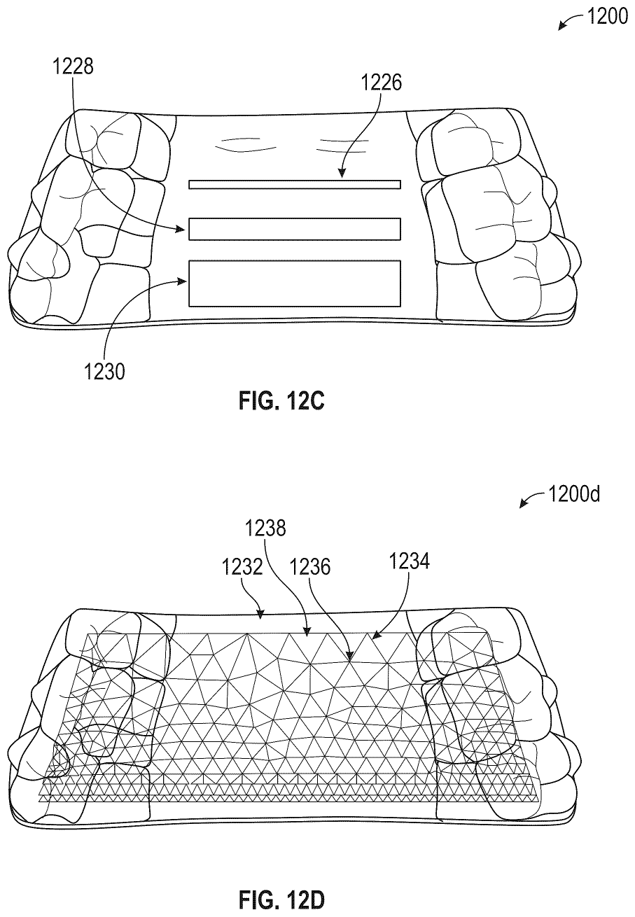

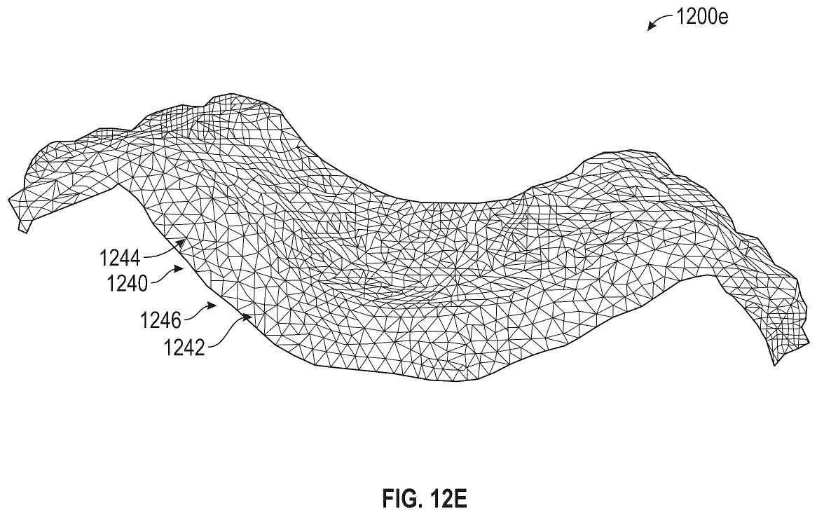

FIGS. 12A-12E illustrate various examples of palatal orthodontic devices, in accordance with embodiments of the present technology. Specifically, FIG. 12A illustrates a directly fabricated metal and polymer retainer 1200a with palatal coverage, FIG. 12B illustrates a metal and polymer palatal expander 1200b with a directly fabricated adjustment device, and FIGS. 12C-12E illustrate directly fabricated metal and polymer palatal expanders 1200c-1200e.

With reference to FIG. 12A, a directly fabricated metal and polymer retainer 1200a with palatal coverage is shown. The metal and polymer retainer 1200a can be directly fabricated in a single fabrication process. For example, the metal and polymer portions of the retainer 1200a can be fabricated simultaneously or in a plurality of layers, with the polymer layers and metal layers fabricated one after another during the single fabrication process. In some embodiments, a single directly fabricated layer may include both polymer portions and metal portions.

The directly fabricated metal and polymer retainer 1200a can include one or more tooth receiving cavities 1202 for receiving the patient's teeth. For example, the polymer retainer 1200a includes two tooth receiving cavities 1202 for anchoring molars and four tooth receiving cavities 1202 for anchoring the central and lateral incisors. The directly fabricated metal and polymer retainer 1200a can also include a palatal region 1204 that covers the patient's palate and spans from the right side of the patient's arch to the left side of the patient's arch. The tooth receiving cavities 1202 and palatal region 1204 can be made from predominantly polymer material. The palatal region 1204 can include metal reinforcements, such as metal reinforcement members 1206 and 1208. The metal reinforcement members 1206, 1208 can be metal fibers or bars that extend across the patient's palate between the right side of the patient's arch and the left side of the patient's arch.

The reinforcement members 1206, 1208 of the retainer 1200a can be fabricated using any suitable technique, such as an inkjet process. Optionally, portions of the reinforcement members that are aligned (e.g., parallel) with each other (e.g., the portions spanning the palatal region 1204) can be formed using an external magnetic field to align the metal particles in the desired direction.

With reference to FIG. 12B, a metal and polymer palatal expander 1200b with a directly fabricated adjustment device is shown. The metal and polymer palatal expander 1200b can be directly fabricated in a single fabrication process. For example, the metal and polymer portions of the palatal expander 1200b can be fabricated simultaneously or in a plurality of layers, with the polymer layers and metal layers fabricated one after another during the single fabrication process. In some embodiments, a single directly fabricated layer may include both polymer portions and metal portions.

The directly fabricated metal and polymer palatal expander 1200b can be removably attached to the patient's teeth. The metal and polymer palatal expander 1200b can include one or more dental portions 1210 including metal reinforcements 1212 for attaching the palatal expander 1200b to the patient's teeth. The palatal expander can include two polymer portions 1214, 1216 coupled together via an adjustment device 1218.

The adjustment device 1218 can provide a mechanism for pushing the first polymer portion 1214 and the second polymer portion 1216 of the palatal expander 1200b away from each other to apply a force to the patient's arch, thereby expanding the patient's arch and palate. The adjustment device 1218 can include two adjustment guides 1220. The adjustment guides 1220 can include hollow cylindrical shafts directly fabricated within each of the first and second polymer portions 1214, 1216 and a shaft extending through the hollow cylindrical shafts. Such an arrangement can provide for controlled and uniform expansion of the palatal expander 1200b.

The adjustment device 1218 can further include two hollow or internally threaded shafts 1222 each directly fabricated within a respective polymer portion 1214, 1216. The internal surface of the hollow threaded shafts 1222 can be threaded with opposite thread directions. The adjustment device 1218 can also include a threaded shaft 1224 having two opposite ends, each end being treaded in one of the respective hollow shafts 1222. The threads on the ends of the threaded shaft 1224 may also have opposite threads such that rotation of the threaded shaft 1224 pushes the polymer portions 1214, 1216 away from each other.

The polymer portions 1214, 1216, the metal reinforcements 1212, and/or the adjustment device 1218 can be directly fabricated in a single fabrication process. For example, the polymer and metal portions may be fabricated layer by layer such that the metal portions of the adjustment device 1218 are directly fabricated in or with the polymer portions 1214, 1216 as opposed to, for example, forming the polymer portions around prefabricated metal adjustment portions. For example, the polymer portions 1214, 1216 can be fabricated using a DLP or SLA technique, while the metal reinforcements 1212 and/or the adjustment device 1218 can be fabricated using material jetting process (e.g., an aerosol jetting process, an inkjet process, a robotic spray coating process), an extrusion process (e.g., a FDM process, a DIW process), or an electrophotography process (e.g., a selective thermoplastic electrophotographic process).

With reference to FIGS. 12C-12E, directly fabricated metal and polymer palatal expanders 1200c-1200e are shown. FIG. 12C depicts directly fabricated metal reinforcements 1226, 1228, and 1230 within a polymeric palatal expander 1200c. Palatal expanders, such as palatal expander 1200c, exert a palatal expansion force on the arches and palate of a patient in order to increase the size of the palate and the arch of the patient. Increasing the size of the palate and arch of the patient can provide more room for the movement and positioning of the patient's teeth to alleviate crowding and other orthodontic issues.

The forces exerted by a palatal expander can increase from the anterior portion of the arch towards the posterior portion of the arch. In a pure polymer palatal expander, the thickness of the palatal expander can also increase from the anterior portion of the palatal expander towards the posterior portion of the palatal expander. In some cases, the thickness may increase to a point where it interferes with the patient's daily activities such as speaking and eating, which may lead to patient compliance issues and delayed or failed treatments.

Reinforcing polymeric palatal expanders with metal or other stiff materials can allow for a uniform thickness across the palatal expander and/or a reduced thickness as compared to a palatal expander exerting similar forces without metal reinforcements. As shown in FIG. 12C, metal reinforcements 1226, 1228, 1230 with varying widths and/or thicknesses can be used to add additional strength and rigidity to the palatal expander 1200c. The thickness and/or width of the metal reinforcements 1226, 1228, 1230 can increase based on the relative posterior position of the directly fabricated metal reinforcement. A first metal reinforcement 1226 can be located anteriorly of other metal reinforcements and can be thinner than the other metal reinforcements 1228, 1230 in one or more of thickness and width. A second metal reinforcement 1228 can be thinner than the metal reinforcement 1230 in one or more of thickness and width, while being thicker than the metal reinforcement 1226 in one or more of thickness and width. In some embodiments, a third metal reinforcement 1230 located posteriorly of the other metal reinforcements 1226, 1228 can be thicker than the other metal reinforcements 1226, 1228 in one or more of thickness and width.

Through the use of digital treatment planning, the desired forces applied by the palatal expander 1200c to the patient's dentition can be modeled. The location and size of the directly fabricated reinforcements 1226, 1228, 1230 can be determined based on the modeled forces. In some embodiments, palatal expanders for patients with steep or wide arches may include more embedded metal reinforcements than palatal expanders for patients with narrow and shallow arches.

The palatal expander 1200c can be fabricated using any suitable technique. For example, the polymeric portions of the palatal expander 1200c can be fabricated using a DLP or SLA technique, while the metal reinforcements 1226, 1228, 1230 can be fabricated using material jetting process (e.g., an inkjet process).

FIG. 12D depicts a polymeric palatal expander 1200d with a metal lattice reinforcement structure 1232. The metal lattice structure 1232 can be a 2D lattice including a plurality of 2D polygons formed from three or more edges 1234 joined at three or more vertices 1236. For example, the 2D metal lattice structure 1232 includes a plurality of triangular elements 1238 each having three edges 1234 and three vertices 1236. Each vertex 1236 within the interior of the lattice structure 1232 connects to six edges 1234 of six adjacent triangular lattice elements 1238. Each edge 1234 of each triangular element 1238 is shared with an adjacent triangular clement 1238.

The palatal expander 1200d can be fabricated using any suitable technique. For example, the polymeric portions of the palatal expander 1200d can be fabricated using a DLP or SLA technique, while the metal lattice structure 1232 can be fabricated using material jetting process (e.g., an inkjet process).

FIG. 12E depicts a polymeric palatal expander 1200e with a 3D metal lattice reinforcement structure 1240. The metal lattice structure 1240 can be a 3D lattice including a plurality of 2D polygons formed from three or more edges 1242 joined at three or more vertices 1244 to make a plurality of tetrahedrons. For example, the 3D metal lattice structure 1240 includes a plurality of tetrahedron elements 1246 each having four triangular faces formed from three edges 1242 and three vertices 1244. Each vertex 1244 within the interior of the lattice structure 1240 connects to at least six adjacent tetrahedron elements 1246. Each edge 1242 of each tetrahedron element 1246 is shared with at least two adjacent tetrahedron elements 1246.

The palatal expander 1200e can be fabricated using any suitable technique. For example, the polymeric portions of the palatal expander 1200e can be fabricated using a DLP or SLA technique, while the metal lattice structure 1240 can be fabricated using material jetting process (e.g., an inkjet process).

A dental appliance can be operably coupled to a monitoring device (also referred to herein as an “electronic compliance indicator”) configured to provide data related to appliance usage and/or patient compliance, such as data indicative of whether the appliance is being worn, the amount of time the appliance is worn, and/or interaction between the appliance and the intraoral cavity (e.g., contact between the appliance and intraoral tissues, force and/or pressure applied by the appliance to intraoral tissues). Alternatively or in combination, the monitoring device can be configured to provide data indicative of one or more characteristics of the patient's intraoral cavity or a portion thereof (e.g., teeth, gingiva, palate, lips, tongue, checks, saliva, airway), such as temperature, color, sound, vibration, motion, pH, conductivity, charge, resistance, capacitance, humidity, or gas flow. The characteristics of the patient's intraoral cavity can optionally be used to determine appliance usage and/or patient compliance.

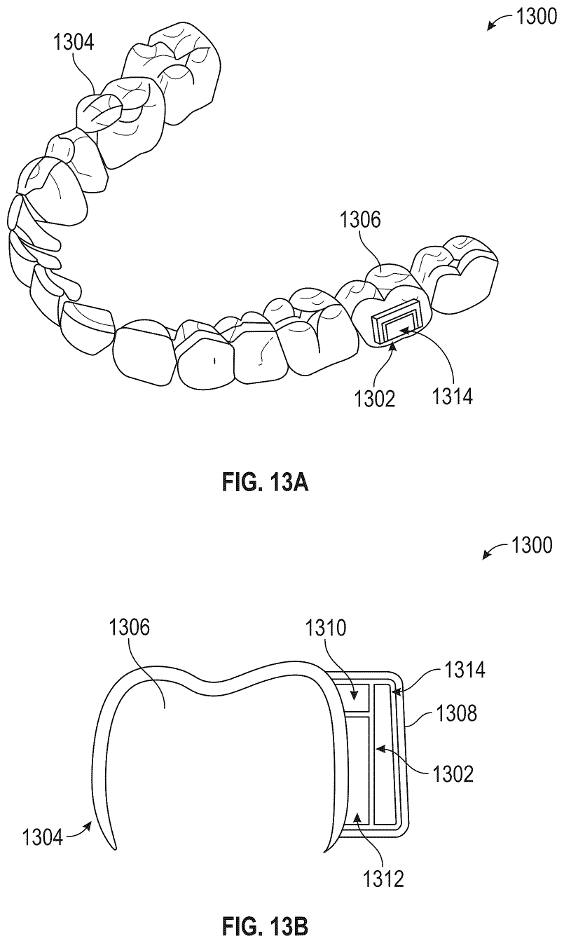

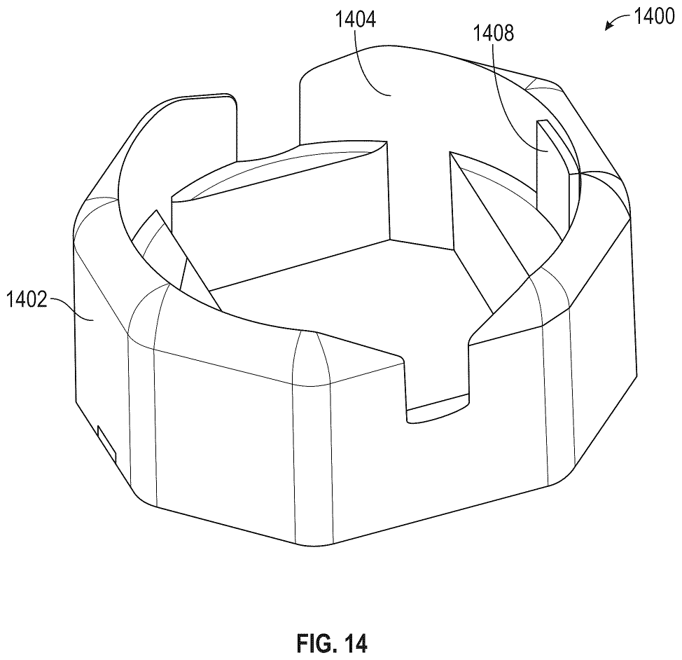

FIGS. 13A and 13B illustrate a dental appliance 1300 including an integrated monitoring device 1302, in accordance with embodiments of the present technology. The appliance 1300 includes a shell 1304 having a plurality of teeth receiving cavities, and the monitoring device 1302 is coupled to an outer, buccal surface of the shell 1304 adjacent a tooth receiving cavity 1306. In the depicted embodiment, the monitoring device 1302 is coupled to a tooth receiving cavity 1306 for a molar. It shall be appreciated that in alternative embodiments, the monitoring device 1302 can be coupled to other portions of the shell 1304, such as an inner surface, a lingual surface, an occlusal surface, one or more tooth receiving cavities for other types of teeth (e.g., incisor, canine, premolar), etc. The monitoring device 1302 can be shaped to conform to the geometry of the corresponding appliance portion (e.g., the wall of the cavity 1306) so as to provide a lower surface profile and reduce patient discomfort. In some embodiments, the appliance 1300 includes a receptacle 1308 formed on the outer surface of the shell 1304 and the monitoring device 1302 is positioned within the receptacle 1308.

The monitoring device 1302 can include a sensor 1310, a power source 1312 (e.g., a battery), a communication unit 1314 (e.g., a wireless antenna), and/or additional electronics (e.g., a processor, memory, other circuitry, etc.—not shown). The arrangement of the components of the monitoring device 1302 can be varied as desired. In some embodiments, the sensor 1310 is located adjacent to the tooth receiving cavity 1306. A gap can be formed in the shell 1304 adjacent to the sensor 1310 so as to permit direct access to the received tooth. The communication unit 1314 (or a component thereof, such as an antenna) can be located adjacent to or on the outer surface of the receptacle 1308 so as to facilitate data transmission. The remaining components of the monitoring device 1302 can be positioned within the receptacle 1308.

The monitoring device 1302 can include any number of sensors 1310, such as one, two, three, four, five, or more sensors 1310. In some embodiments, the use of multiple sensors provides redundancy to increase the accuracy and reliability of the resultant data. Some or all of the sensors 1310 can be of the same type. Some or all of the sensors 1310 can be of different types. Examples of sensor types suitable for use in the monitoring device 1302 include: touch or tactile sensors (e.g., capacitive, resistive), proximity sensors, audio sensors (e.g., microelectromechanical system (MEMS) microphones), color sensors (e.g., RGB color sensors), electromagnetic sensors (e.g., magnetic reed sensors, magnetometer), light sensors, force sensors (e.g., force-dependent resistive materials), pressure sensors, temperature sensors, motion sensors (e.g., accelerometers, gyroscopes), vibration sensors, piezoelectric sensors, strain gauges, pH sensors, conductivity sensors, gas flow sensors, gas detection sensors, humidity or moisture sensors, physiological sensors (e.g., electrocardiogramsors, bio-impedance sensors, photoplethysmography sensors, galvanic skin response sensors), or combinations thereof. In some embodiments, the sensors 1310 can be configured as a switch that is activated and/or deactivated in response to a particular type of signal (e.g., optical, electrical, magnetic, mechanical, etc.).

The monitoring device 1302 can be powered by the power source 1312, which can be a battery. In some embodiments, the power source 1312 is a printed and/or flexible battery, such as a zinc-carbon flexible battery, a zinc-manganese dioxide printed flexible battery, or a solid-state thin film lithium phosphorus oxynitride battery. The use of printed and/or flexible batteries can be advantageous for reducing the overall size of the monitoring device 1302 and avoiding patient discomfort. For example, printed batteries can be fabricated in a wide variety of shapes and can be stacked to make three-dimensional structures, e.g., to conform the appliance and/or teeth geometries. Likewise, flexible batteries can be shaped to lie flush with the surfaces of the appliance and/or teeth. Alternatively or in combination, other types of batteries can be used, such as supercapacitors. In some embodiments, the power source 1312 can utilize lower power energy harvesting methods (e.g., thermodynamic, electrodynamic, piezoelectric) in order to generate power for the monitoring device 1302. Optionally, the power source 1312 can be rechargeable, for example, using inductive or wireless methods. In some embodiments, the patient can recharge the power source 1312 when the appliance 1300 is not in use. For example, the patient can remove the appliance 1300 when brushing the teeth and place the appliance 1300 on an inductive power hub to recharge the power source 1312.

The communication unit 1314 can be configured to transmit the data to a remote device. The communication unit 1314 can utilize any suitable communication method, such as wired or wireless communication methods (e.g., RFID, near-field communication, Bluetooth, ZigBee, infrared, etc.). The communication unit 1314 can include a transmitter for transmitting data to the remote device and an antenna. Optionally, the communication unit 1314 includes a receiver for receiving data from the remote device. In some embodiments, the communication channel utilized by the communication unit 1314 can also be used to power the device 1302, e.g., during data transfer or if the device 1302 is used passively.

The remote device can be any computing device or system, such as a mobile device (e.g., smartphone), personal computer, laptop, tablet, wearable device, etc. Optionally, the remote device can be a part of or connected to a cloud computing system (“in the cloud”). The remote device can be associated with the patient, the treating practitioner, medical practitioners, researchers, etc. In some embodiments, the remote device is configured to process and analyze the data from the monitoring device 1302, e.g., in order to monitor patient compliance and/or appliance usage, for research purposes, and the like.

In some embodiments, the appliance 1300 includes one or more conductive structures (e.g., wires, traces, contacts, microstrips, buses, etc.—not shown) that are configured to electrically couple to one or more components of the monitoring device 1302, such as the sensor 1310, power source 1312, communication unit 1314, and/or other electronics (e.g., a processor, memory, other circuitry). In such embodiments, the conductive structures can route electrical signals between different components of the monitoring device 1302, and/or from a component of the monitoring device 1302 to another component (e.g., electronics at a different location on the appliance 1300 or on a different appliance). Alternatively or in combination, the appliance 1300 can include one or more conductive structures that serve as part of a component of the monitoring device 1302. For instance, the conductive structure can serve as an antenna of the communication unit 1314. As another example, the conductive structure can serve as an electrode of the sensor 1310.

The appliance 1300 can be fabricated using any suitable technique. For example, the shell 1304 and receptacle 1308 can be fabricated using a DLP or SLA technique, while the conductive structure(s) can be fabricated using a material jetting process (e.g., an inkjet process).

FIG. 14 is a perspective view of a housing 1400 for a power source of a dental appliance, in accordance with embodiments of the present technology. The housing 1400 can be coupled to or integrally formed with a polymeric shell of the dental appliance. As shown in FIG. 14, the housing 1400 can include a receptacle 1402 having one or more sidewalls 1404, and a recess 1406 configured to receive a power source. The power source (e.g., a battery) can be configured to provide power to at least one electronic component of the dental appliance, such as a sensor, an actuator, a processor, a memory, etc. The housing 1400 can include one or more contacts 1408 positioned within the receptacle 1402 such that, when the power source is inserted into the recess 1406, the contacts 1408 are electrically coupled to the power source (e.g., to one or both terminals of the battery). The contacts 1408 can also be electrically coupled to the electronic component to allow for transmission of power from the power source to the electronic component. For example, the housing 1400 and/or the polymeric shell can include additional wires, traces, contacts, etc., that connect the contacts 1408 to the electronic component.

The housing 1400 can be fabricated using any suitable technique. For example, the sidewalls 1404 of the receptacle 606 can be fabricated using a DLP or SLA technique, while the contacts 1408 can be fabricated using a material jetting process (e.g., an inkjet process).

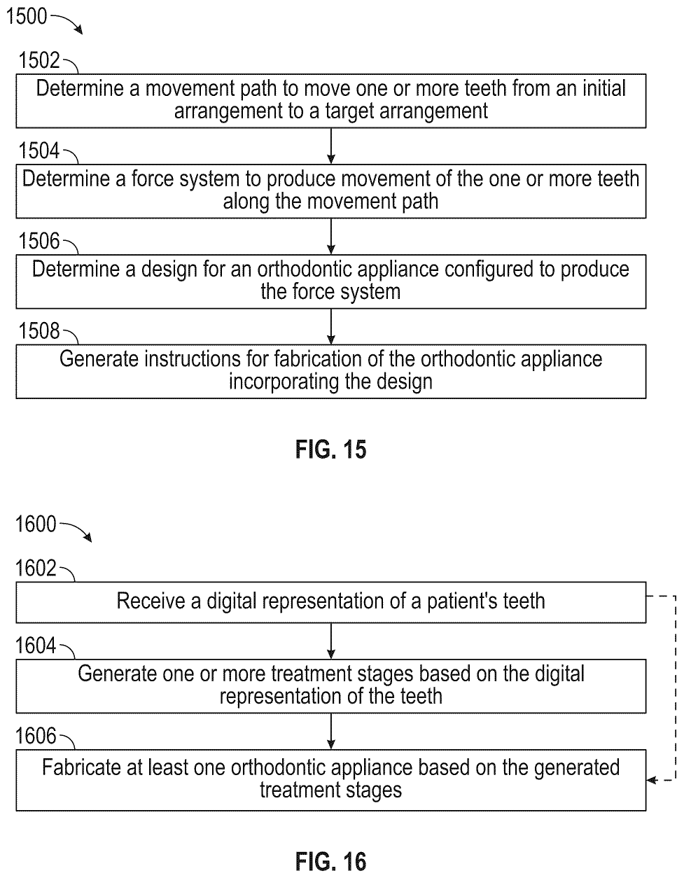

FIG. 15 illustrates a method 1500 for designing an orthodontic appliance, in accordance with embodiments of the present technology. The method 1500 can be applied to any embodiment of the orthodontic appliances described herein. Some or all of the steps of the method 1500 can be performed by any suitable data processing system or device, e.g., one or more processors configured with suitable instructions.

In block 1502, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1504, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 1504 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age-for example, young juvenile patients can require lower forces to expand the suture than older patients, as the suture has not yet fully formed.

In block 1506, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 1508, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 1500 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 1500 may be performed with any suitable fabrication system or device, such as the embodiments described herein. Some of the steps may be optional, e.g., the process of block 1504 can be omitted, such that the orthodontic appliance is designed based on the desired tooth movements and/or determined tooth movement path, rather than based on a force system. Moreover, the order of the steps can be varied as desired.

FIG. 16 illustrates a method 1600 for digitally planning an orthodontic treatment and/or design or fabrication of an appliance, in accordance with embodiments. The method 1600 can be applied to any of the treatment procedures described herein and can be performed by any suitable data processing system.

In block 1602 a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 1604, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 1606, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 16, design and/or fabrication of an orthodontic appliance, and perhaps a particular orthodontic treatment, may include use of a representation of the patient's teeth (e.g., including receiving a digital representation of the patient's teeth (block 1602)), followed by design and/or fabrication of an orthodontic appliance based on a representation of the patient's teeth in the arrangement represented by the received representation.

As noted herein, the techniques described herein can be used for the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to manufacture attachment placement devices, e.g., appliances used to position prefabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled, “Dental Attachment Placement Structure,” filed Mar. 27, 2019; U.S. application Ser. No. 15/674,662, entitled “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/22,552, entitled “Devices, Systems, and Methods for Dental Arch Expansion,” filed Jun. 28, 2018; U.S. Pat. No. 11,45,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### Examples

The following examples are included to further describe some aspects of the present technology, and should not be used to limit the scope of the technology.

Example 1. A method comprising:
receiving a digital representation of a dental appliance, wherein the dental appliance comprises a first portion to be formed from a polymeric material and a second portion to be formed from a metallic material; and
fabricating the dental appliance using an additive manufacturing process, wherein the additive manufacturing process comprises:
   depositing a first composition comprising a precursor of the polymeric material at the first portion of the dental appliance, and
   depositing a second composition comprising a plurality of metal particles at the second portion of the dental appliance.

Example 2. The method of Example 1, wherein the plurality of metal particles are metal nanoparticles.

Example 3. The method of Example 1 or 2, wherein the plurality of metal particles have a diameter less than or equal to 500 nm.

Example 4. The method of any one of Examples 1 to 3, wherein the plurality of metal particles comprise one or more of the following: silver, gold, platinum, palladium, copper, nickel, zinc, iron, or titanium, or a compound thereof.

Example 5. The method of any one of Examples 1 to 4, wherein the plurality of metal particles comprise magnetic nanoparticles.

Example 6. The method of Example 5, wherein the magnetic nanoparticles comprise ferrite nanoparticles.

Example 7. The method of any one of Examples 1 to 6, further comprising causing the plurality of metal particles to aggregate.

Example 8. The method of any one of Examples 1 to 7, wherein the additive manufacturing process further comprises sintering the plurality of metal particles to form a continuous metallic structure.

Example 9. The method of Example 8, wherein the plurality of metal particles are sintered by heating the second portion of the dental appliance to an elevated temperature.

Example 10. The method of Example 9, wherein the elevated temperature is less than 100° C.

Example 11. The method of Example 9 or 10, wherein the elevated temperature is less than a melting point of the first portion of the dental appliance.

Example 12. The method of any one of Examples 8 to 11, wherein the plurality of metal particles are sintered by applying one or more of ultraviolet light, infrared light, or visible light to the second portion of the dental appliance.

Example 13. The method of any one of Examples 8 to 12, wherein the additive manufacturing process further comprises applying energy to cure the precursor of the polymeric material, wherein the energy causes the sintering of the plurality of metal particles.

Example 14. The method of any one of Examples 1 to 13, wherein the second composition comprises a solvent, and the plurality of metal particles are dispersed in the solvent.

Example 15. The method of Example 14, wherein the additive manufacturing process further comprises removing the solvent from the plurality of metal particles.

Example 16. The method of Example 15, wherein the solvent is removed by one or more of evaporation, aerosolization, or diffusion.

Example 17. The method of any one of Examples 1 to 16, wherein the second composition is deposited using a material jetting technique or a fused deposition modeling technique.

Example 18. The method of any one of Examples 1 to 17, wherein the additive manufacturing process further comprises curing the precursor of the polymeric material to form the polymeric material.

Example 19. The method of Example 18, wherein the precursor of the polymeric material is cured using a stereolithography technique or a digital light processing technique.

Example 20. The method of any one of Examples 1 to 19, wherein the precursor of the polymeric material comprises a curable resin.

Example 21. The method of any one of Examples 1 to 20, wherein the additive manufacturing process comprises building up the first and second portions of the dental appliance in a plurality of layers.

Example 22. The method of Example 21, wherein the digital representation comprises a 3D model of the dental appliance, and the method further comprises:
generating a plurality of 2D cross-sections from the 3D model of the dental appliance, wherein the plurality of 2D cross-sections correspond to the plurality of layers, and
identifying, in one or more 2D cross-sections, a first region to be formed from the first composition and a second region to be formed from the second composition.

Example 23. The method of Example 22, wherein:
the first composition is deposited based on the first region identified in the one or more 2D cross-sections, and
the second composition is deposited based on the second region identified in the one or more 2D cross-sections.

Example 24. The method of any one of Examples 1 to 23, wherein the first portion differs from the second portion with respect to one or more of the following: stiffness, strength, hardness, electrical conductivity, or magnetism.

Example 25. The method of any one of Examples 1 to 24, wherein the second portion comprises a reinforcement structure of the dental appliance.

Example 26. The method of Example 25, wherein the reinforcement structure comprises one or more of the following: a fiber, a bar, a lattice, a layer, or a patch.

Example 27. The method of any one of Examples 1 to 26, wherein the second portion comprises an auxiliary structure of the dental appliance.

Example 28. The method of Example 27, wherein the auxiliary structure comprises one or more of the following: a hook, a button, a distalizer, a power arm, a bracket, a wire, a spring, a palatal expander, or a lingual retainer.

Example 29. The method of any one of Examples 1 to 28, wherein the second portion comprises a conductive structure of the dental appliance.

Example 30. The method of Example 29, wherein the conductive structure comprises one or more of the following: a wire, a trace, a contact, an electrode, or an antenna.

Example 31. The method of Example 29 or 30, wherein the conductive structure is configured to couple to one or more of the following: a battery, a sensor, an electronic compliance indicator, or an actuator.

Example 32. A method comprising:
determining an appliance geometry for a dental appliance, wherein the dental appliance comprises a first portion to be formed from a polymeric material and a second portion to be formed from a metallic material; and
generating instructions for fabricating the dental appliance using an additive manufacturing process, wherein the additive manufacturing process comprises:
   depositing a first composition comprising a precursor of the polymeric material at the first portion of the dental appliance, and
   depositing a second composition comprising a plurality of metal particles at the second portion of the dental appliance.

Example 33. The method of Example 32, further comprising generating a 3D model of the dental appliance having the appliance geometry.

Example 34. The method of Example 33, further comprising:
generating a plurality of 2D cross-sections from the 3D model of the dental appliance, wherein the plurality of slices correspond to a plurality of layers for building up the dental appliance using the additive manufacturing process, and
identifying, in one or more 2D cross-sections, a first region to be formed from the first composition and a second region to be formed from the second composition.

Example 35. The method of Example 34, further comprising:
generating instructions for depositing the first composition based on the first region of the one or more 2D cross-sections, and
generating instructions for depositing the second composition based on the second region of the one or more 2D cross-sections.

Example 36. The method of any one of Examples 32 to 35, wherein determining the appliance geometry comprises:
receiving a treatment plan for repositioning a patient's teeth from a first arrangement toward a second arrangement using the dental appliance, and
determining one or more forces to be applied to the patient's teeth by the dental appliance, and
identifying the first and second portions of the dental appliance based on the one or more forces.

Example 37. The method of any one of Examples 32 to 35, wherein determining the appliance geometry comprises:
generating a first digital representation of a shell comprising a plurality of teeth-receiving cavities,
generating a second digital representation of one or more of a reinforcement structure, an auxiliary structure, or a conductive structure associated with the shell, and
identifying the first and second portions of the dental appliance based on the first and second digital representations.

Example 38. The method of Example 37, wherein the second digital representation comprises the reinforcement structure, and the reinforcement structure comprises one or more of the following: a fiber, a bar, a lattice, a layer, or a patch.

Example 39. The method of Example 37 or 38, wherein the second digital representation comprises the auxiliary structure, and the auxiliary structure comprises one or more of the following: a hook, a button, a distalizer, a power arm, a bracket, a wire, a spring, a palatal expander, or a lingual retainer.

Example 40. The method of any one of Examples 37 to 39, wherein the second digital representation comprises the conductive structure, and the conductive structure comprises one or more of the following: a wire, a trace, a contact, an electrode, or an antenna.

Example 41. The method of any one of Examples 37 to 40, wherein the second digital representation comprises the conductive structure, and the conductive structure is configured to couple to one or more of the following: a battery, a sensor, an electronic compliance indicator, or an actuator.

Example 42. The method of any one of Examples 32 to 41, wherein the plurality of metal particles are metal nanoparticles.

Example 43. The method of any one of Examples 32 to 42, wherein the plurality of metal particles have a diameter less than or equal to 500 nm.

Example 44. The method of any one of Examples 32 to 43, wherein the additive manufacturing process further comprises causes the plurality of metal particles to aggregate.

Example 45. The method of any one of Examples 32 to 44, wherein the additive manufacturing process further comprises sintering the plurality of metal particles to form a continuous metallic structure.

Example 46. The method of any one of Examples 32 to 45, wherein the second composition comprises a fluid, and the plurality of metal particles are dispersed in the fluid.

Example 47. The method of any one of Examples 32 to 46, wherein the second composition is deposited using a material jetting technique or a fused deposition modeling technique.

Example 48. The method of any one of Examples 32 to 47, wherein the additive manufacturing process further comprises curing the precursor of the polymeric material to form the polymeric material.

Example 49. The method of Example 48, wherein the precursor of the polymeric material is cured using a stereolithography technique or a digital light processing technique.

Example 50. The method of any one of Examples 32 to 49, wherein the precursor of the polymeric material comprises a polymerizable resin.

Example 51. The method of any one of Examples 32 to 50, wherein the first portion differs from the second portion with respect to one or more of the following: stiffness, strength, hardness, electrical conductivity, or magnetism.

Example 52. A system comprising:
one or more processors; and
memory operably coupled to the one or more processors and comprising instructions that, when executed by the one or more processors, cause the system to perform operations comprising the method of any one of Examples 1 to 51.

Example 53. A non-transitory computer-readable medium comprising instructions that, when executed by one or more processors of a computing system, cause the computing system to perform operations comprising the method of any one of Examples 1 to 51.

Example 54. A system comprising:
a controller configured to receive a digital representation of a dental appliance, wherein the dental appliance comprises a first portion to be formed from a polymeric material and a second portion to be formed from a metallic material; and
an additive manufacturing system operably coupled to the controller and configured to fabricate the dental appliance based on the digital representation, wherein the additive manufacturing system comprises:
   a first material source configured to deposit a first composition comprising a precursor of the polymeric material at the first portion of the dental appliance, and
   a second material source configured to deposit a second composition comprising a plurality of metal particles at the second portion of the dental appliance.

Example 55. The system of Example 54, wherein the plurality of metal particles are metal nanoparticles.

Example 56. The system of Example 54 or 55, wherein the plurality of metal particles have a diameter less than or equal to 500 nm.

Example 57. The system of any one of Examples 54 to 56, wherein the plurality of metal particles comprise one or more of the following: silver, gold, platinum, palladium, copper, nickel, zinc, iron, or titanium, or a compound thereof.

Example 58. The system of any one of Examples 54 to 57, wherein the plurality of metal particles comprise magnetic nanoparticles.

Example 59. The method of Example 58, wherein the magnetic nanoparticles comprise ferrite nanoparticles.

Example 60. The system of any one of Examples 54 to 59, wherein the additive manufacturing system is configured to cause the plurality of metal particles to aggregate after deposition.

Example 61. The system of any one of Examples 54 to 60, wherein the additive manufacturing system is configured to sinter the plurality of metal particles to form a continuous metallic structure.

Example 62. The system of Example 61, wherein the additive manufacturing system comprises an energy source configured to output energy to heat the second portion of the dental appliance to an elevated temperature to sinter the plurality of metal particles.

Example 63. The system of Example 62, wherein the elevated temperature is less than 100° C.

Example 64. The system of Example 62 or 63, wherein the elevated temperature is less than a melting point of the first portion of the dental appliance.

Example 65. The system of any one of Examples 62 to 64, wherein the energy comprises one or more of ultraviolet light, infrared light, or visible light.

Example 66. The system of any one of Examples 62 to 65, wherein the energy from the energy source cures the precursor of the polymeric material.

Example 67. The system of any one of Examples 54 to 66, wherein the second composition comprises a solvent, and the plurality of metal particles are dispersed in the solvent.

Example 68. The system of Example 67, wherein the additive manufacturing system is configured to remove the solvent from the plurality of metal particles.

Example 69. The system of Example 68, wherein the solvent is removed by one or more of evaporation, aerosolization, or diffusion.

Example 70. The system of any one of Examples 54 to 69, wherein the second material source comprises one or more nozzles configured to deposit the second composition using a material jetting technique or a fused deposition modeling technique.

Example 71. The system of any one of Examples 54 to 70, wherein the additive manufacturing system comprises an energy source configured to output energy to cure the precursor of the polymeric material to form the polymeric material.

Example 72. The system of Example 71, wherein the energy source is configured to cure the precursor of the polymeric material using a stereolithography technique or a digital light processing technique.

Example 73. The system of any one of Examples 54 to 72, wherein the precursor of the polymeric material comprises a curable resin.

Example 74. The system of any one of Examples 54 to 73, wherein the additive manufacturing system is configured to build up the first and second portions of the dental appliance in a plurality of layers.

Example 75. The system of Example 74, wherein the digital representation comprises a plurality of 2D cross-sections of the dental appliance corresponding to the plurality of layers, and wherein one or more of the 2D cross-sections comprise a first region to be formed from the first composition and a second region to be formed from the second composition.

Example 76. The system of Example 75, wherein:
the first material source is configured to deposit the first composition based on the first region in the one or more 2D cross-sections, and
the second material source is configured to deposit the second composition based on the second region in the one or more 2D cross-sections.

Example 77. The system of any one of Examples 54 to 76, wherein the first portion differs from the second portion with respect to one or more of the following: stiffness, strength, hardness, electrical conductivity, or magnetism.

Example 78. The system of any one of Examples 54 to 77, wherein the second portion comprises a reinforcement structure of the dental appliance.

Example 79. The system of Example 78, wherein the reinforcement structure comprises one or more of the following: a fiber, a bar, a lattice, a layer, or a patch.

Example 80. The system of any one of Examples 54 to 79, wherein the second portion comprises an auxiliary structure of the dental appliance.

Example 81. The system of Example 80, wherein the auxiliary structure comprises one or more of the following: a hook, a button, a distalizer, a power arm, a bracket, a wire, a spring, a palatal expander, or a lingual retainer.

Example 82. The system of any one of Examples 54 to 81, wherein the second portion comprises a conductive structure of the dental appliance.

Example 83. The system of Example 82, wherein the conductive structure comprises one or more of the following: a wire, a trace, a contact, an electrode, or an antenna.

Example 84. The system of Example 82 or 83, wherein the conductive structure is configured to couple to one or more of the following: a battery, a sensor, an electronic compliance indicator, or an actuator.

### Conclusion

Although many of the embodiments are described above with respect to systems, devices, and methods for manufacturing dental appliances, the technology is applicable to other applications and/or other approaches, such as manufacturing of other types of objects. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1-16.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A method comprising:
receiving a digital representation of a dental appliance, wherein the dental appliance comprises a first portion to be formed from a polymeric material and a second portion to be formed from a metallic material; and
fabricating the dental appliance using an additive manufacturing process, wherein the additive manufacturing process comprises:
depositing a first composition comprising a precursor of the polymeric material at the first portion of the dental appliance, and
depositing a second composition comprising a plurality of metal particles at the second portion of the dental appliance.

2. The method of claim 1, wherein the plurality of metal particles are metal nanoparticles.

3. The method of claim 1, wherein the plurality of metal particles have a diameter less than or equal to 500 nm.

4. The method of claim 1, further comprising causing the plurality of metal particles to aggregate.

5. The method of claim 1, wherein the additive manufacturing process further comprises sintering the plurality of metal particles to form a continuous metallic structure.

6. The method of claim 5, wherein the plurality of metal particles are sintered by heating the second portion of the dental appliance to an elevated temperature.

7. The method of claim 6, wherein the elevated temperature is less than 100° C.

8. The method of claim 6, wherein the elevated temperature is less than a melting point of the first portion of the dental appliance.

9. The method of claim 5, wherein the plurality of metal particles are sintered by applying one or more of ultraviolet light, infrared light, or visible light to the second portion of the dental appliance.

10. The method of claim 5, wherein the additive manufacturing process further comprises applying energy to cure the precursor of the polymeric material, wherein the energy causes the sintering of the plurality of metal particles.

11. The method of claim 1, wherein the second composition comprises a solvent, and the plurality of metal particles are dispersed in the solvent.

12. The method of claim 11, wherein the additive manufacturing process further comprises removing the solvent from the plurality of metal particles.

13. The method of claim 12, wherein the solvent is removed by one or more of evaporation, aerosolization, or diffusion.

14. The method of claim 1, wherein the second composition is deposited using a material jetting technique or a fused deposition modeling technique.

15. The method of claim 1, wherein the additive manufacturing process further comprises curing the precursor of the polymeric material to form the polymeric material.

16. The method of claim 15, wherein the precursor of the polymeric material is cured using a stereolithography technique or a digital light processing technique.

17. The method of claim 1, wherein the precursor of the polymeric material comprises a curable resin.

18. The method of claim 1, wherein the additive manufacturing process comprises building up the first and second portions of the dental appliance in a plurality of layers.

19. The method of claim 18, wherein the digital representation comprises a 3D model of the dental appliance, and the method further comprises:
generating a plurality of 2D cross-sections from the 3D model of the dental appliance, wherein the plurality of 2D cross-sections correspond to the plurality of layers, and
identifying, in one or more 2D cross-sections, a first region to be formed from the first composition and a second region to be formed from the second composition.

20. The method of claim 19, wherein:
the first composition is deposited based on the first region identified in the one or more 2D cross-sections, and
the second composition is deposited based on the second region identified in the one or more 2D cross-sections.
